(19) United States
(12) Patent Application Publication
(10) Pub. No.: US 2021/0082249 A1
(43) Pub. Date: Mar. 18, 2021

(54) GAMING SYSTEM AND METHOD PROVIDING AWARDS FOR PUZZLES

(71) Applicant: ADP GAUSELMANN GMBH, Espelkamp (DE)

(72) Inventor: Carsten Kleine-Vossbeck, Euskirchen (DE)

(21) Appl. No.: 16/573,589

(22) Filed: Sep. 17, 2019

(51) Int. Cl. G07F 17/32

(52) U.S. Cl. CPC G07F 17/3267; G07F 17/3209; G07F 17/34; G07F 17/3244; G07F 17/3239; G07F 17/3213

(57) ABSTRACT

In various implementations, the gaming system and method provide a game where a player obtains puzzle pieces for one or more puzzles. When a player obtains a predetermined quantity of puzzle pieces for a particular puzzle, the gaming system may provide one or more awards for that particular puzzle. In some implementations, the gaming system provides a player with puzzle pieces based on generated symbols in a game.

### FIELD

The present disclosure relates to gaming systems.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

The present disclosure is directed to systems and processes for gaming. A gaming system consistent with implementations disclosed herein provides a game that randomly determines symbols and displays such symbols to players using a display device. The gaming system evaluates the displayed symbols to determine whether they correspond to awards.

In various implementations, the gaming system and method provide a game where a player obtains puzzle pieces for one or more puzzles. In some implementations, the gaming system displays outlines of a puzzle to indicate the shape and quantity of puzzle pieces that a player should strive to obtain. When a player obtains a predetermined quantity of puzzle pieces for a particular puzzle, the gaming system may provide one or more awards for that particular puzzle.

In some implementations, the gaming system provides puzzle pieces associated with generated symbols in a game. In some implementations, one or more winning symbol combinations can be associated with one or more puzzle pieces. For example, the gaming system may generate a quantity of symbols for display in symbol display areas of a game. The gaming system may evaluate the generated quantity of symbols for winning symbols and winning symbol combinations. In some implementations, where the gaming system determines that a winning symbol combination was generated and the winning symbol combination is also associated with a determined quantity of puzzle pieces for a particular puzzle, the gaming system may generate and display the determined quantity of puzzle pieces in appropriate places in the particular puzzle. The gaming system may evaluate the puzzles to determine if a threshold quantity of puzzle pieces are displayed in one or more puzzles. When the threshold quantity of puzzle pieces are displayed in one or more puzzles, the gaming system may provide the player with one or more awards associated with obtaining the threshold quantity of puzzle pieces for one or more puzzles. In some implementations, when generated puzzle pieces are left over or unused (e.g., after filling a puzzle), the gaming system may provide additional awards for one or more puzzle pieces that remain after filling a particular puzzle. In some implementations, the gaming system provides an additional award for each puzzle piece that remains after filling a particular puzzle.

In some implementations, the gaming system includes a plurality of puzzle collection sets. The plurality of puzzle collection sets can include any suitable quantity of puzzle collection sets. For example, the plurality of puzzle collection sets can include two puzzle collection sets (where a puzzle collection set can include one or more puzzles). In some implementations, the plurality of puzzle collection sets can include three, four, or any suitable quantity of puzzle collection sets.

In some implementations, the gaming system receives a player input that results in a selection of one puzzle collection set from the plurality of puzzle collection sets for a play of a game. In some implementations, the player selects a puzzle collection set from the plurality of puzzle collection sets. In some such implementations, the puzzle collection sets are associated with a minimum wager level that a player makes to obtain the selected puzzle collection set for the play of the game. In some implementations, the player places a wager at the gaming system and the gaming system uses this player input to determine which one of the puzzle collections sets to select from the plurality of puzzle collection sets. In some implementations, a first wager is associated with a first puzzle collection set and a second wager is associated with a second puzzle collection set. In some implementations, the first wager is different from the second wager. In some implementations, the first wager is lower than the second wager.

In some implementations, a puzzle is associated with one or more puzzle pieces. The quantity of puzzle pieces to needed to complete a particular puzzle may vary based on a player's wager. A player can obtain the puzzle pieces over one or more plays of a game. In some implementations, the gaming system provides the player with puzzle pieces based on the gaming system generating winning symbols or winning symbol combinations. For example, generating a winning symbol combination of four Cherry symbols may cause the gaming system to provide the player with three puzzle pieces that are associated with a puzzle that partially forms or reveals a Cherry symbol in some implementations. The quantity of puzzle pieces that the gaming system provides to a player for a winning symbol or winning symbol combination may vary based on several different factors, such as a player's wager, random determination, etc. In some implementations, puzzle pieces obtained for a particular puzzle will remain with the particular puzzle for one or more plays of a game. In some implementations, a puzzle may retain puzzle pieces between different gaming sessions. For example, a first player in a first gaming session may obtain five puzzle pieces for a particular puzzle. If the player does not obtain an award for the particular puzzle and ends the gaming session, the gaming system may retain the five puzzle pieces for one or more next players and one or more next gaming sessions in some implementations.

In some implementations, a puzzle collection set can include one or more puzzles. In some implementations, the puzzles are associated with an award. In some implementations, to obtain an award associated with a puzzle, the player completes the puzzle or otherwise obtains a threshold quantity of puzzle pieces for the puzzle. In some implementations, the player can complete more than one puzzle in a play of a game to obtain more than one award associated with respective completed puzzles.

In some implementations, the gaming system may generate a puzzle clearing symbol. In some implementations, when the gaming system generates a puzzle clearing symbol during a play of a game, the gaming system may clear or remove obtained puzzle pieces from one or more puzzles. In some implementations, a puzzle clearing symbol may clear a determined quantity of puzzle pieces from one or more puzzles. In some implementations, different puzzles in a puzzle collection set are associated with different puzzle clearing symbols. For example, a first puzzle can be associated with a first puzzle clearing symbol and a second puzzle can be associated with a second puzzle clearing symbol. In some implementations, where the gaming system generates a second puzzle clearing symbol during a play of the game, the gaming system clears one or more puzzle pieces from the second puzzle (e.g., where the second puzzle includes obtained puzzle pieces) but does not clear the first puzzle of obtained puzzle pieces. As another example, in some implementations, where the gaming system generates a first puzzle clearing symbol during a play of the game, the gaming system clears one or more puzzle pieces from the first puzzle (e.g., where the first puzzle includes obtained puzzle pieces) but does not clear the second puzzle of obtained puzzle pieces.

In some implementations, puzzles in a puzzle collection set can be the same or different puzzles. For example, a puzzle collection set with two puzzles can include two different puzzles. The different puzzles may be associated with a different quantity of puzzle pieces to complete the puzzle. In some implementations, a puzzle collection set with two puzzles can include two different puzzles with the same quantity of puzzle pieces. In some implementations, as puzzle pieces are obtained during a play of a game, an image can be revealed or formed with the puzzle pieces.

As described above and set forth in greater detail below, gaming systems in accordance with aspects of the present disclosure provide a specialized computing device integrating non-generic hardware and software that improve upon the existing technology of human-computer interfaces by providing unconventional functions, operations, and symbol sets for generating interactive displays and outputs. The features of the gaming system provide a practical implementation that improves the operation of the gaming systems for their specialized purpose of providing entertainment by reducing player disappointment with game outcomes, by enhancing player enjoyment, and by increasing player engagement.

### BRIEF DESCRIPTION OF THE DRAWINGS

FIG. 1 shows a perspective view illustrating an example gaming system in accordance with aspects of the present disclosure.

FIG. 2 shows a functional block diagram illustrating a game controller and gaming system in accordance with aspects of the present disclosure.

FIG. 3 illustrates an example of an environment for implementing systems and processes in accordance with aspects of the present disclosure.

FIGS. 4A and 4B show a process flow diagram illustrating an example method of operating the gaming system in accordance with aspects of the present disclosure.

FIGS. 5A, 5B, and 5C show a picture of a game screen displayed by a gaming system in accordance with aspects of the present disclosure.

FIG. 6 shows a picture of various different puzzle collection sets comprising multiple puzzles.

FIGS. 7A and 7B show a picture of a game screen displayed by a gaming system in accordance with aspects of the present disclosure.

### DETAILED DESCRIPTION

The present disclosure provides systems and processes for gaming and amusement devices. In various implementations, the gaming system and method provide a game where a player obtains puzzle pieces for one or more puzzles. In some implementations, the gaming system displays outlines of a puzzle to indicate the quantity of puzzle pieces that a player should strive to obtain. When a player obtains a predetermined quantity of puzzle pieces for a particular puzzle, the gaming system may provide one or more awards for that particular puzzle. In some implementations, the gaming system provides puzzle pieces associated with generated symbols in a game. In some implementations, one or more winning symbols or winning symbol combinations can be associated with one or more puzzle pieces. For example, the gaming system may generate a quantity of symbols for display in symbol display areas of a game. The gaming system may evaluate the generated quantity of symbols for winning symbols and winning symbol combinations. In some implementations, where the gaming system determines that a winning symbol combination was generated and the winning symbol combination is also associated with a determined quantity of puzzle pieces for a particular puzzle, the gaming system may display the determined quantity of puzzle pieces in appropriate places in the particular puzzle. The gaming system may evaluate the puzzles to determine if a threshold quantity of puzzle pieces are displayed in one or more puzzles. When the threshold quantity of puzzle pieces are displayed in one or more puzzles, the gaming system may provide the player with one or more awards associated with obtaining the threshold quantity of puzzle pieces for one or more puzzles.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. In some implementations, a gaming system includes: a display device, an input device, a value dispenser, a random number generator, a memory device, and a processor, where the memory device stores program instructions that are executed by the processor. In some implementations, the gaming system receives, via the input device, a user selection, where the user selection results in selection of a puzzle collection from a plurality of puzzle collection sets for a play of a game. In some implementations, the gaming system determines, using the random number generator, a plurality of symbols for a plurality of symbol display areas. In some implementations, the gaming system displays, on the display device, the plurality of symbols in the plurality of symbol display areas. In some implementations, the gaming system determines at least one winning symbol combination in the plurality of symbols. In some implementations, the gaming system determines a quantity of puzzle pieces to display in the selected puzzle collection based on the at least one winning symbol combination. In some implementations, the gaming system displays the quantity of puzzle pieces in the puzzle collection. In some implementations, the gaming system determines one or more awards based on the puzzle collection displaying a threshold quantity of puzzle pieces. In some implementations, the gaming system issues a value from the value dispenser based on the one or more awards upon receipt of a cash out request. Other implementations may include corresponding computer systems, apparatus, and computer programs recorded on one or more computer storage devices, each configured to perform the actions of the methods.

Implementations may include, but are not limited to, one or more of the following features. The gaming system where the plurality of puzzle collection sets includes at least two different puzzle collections sets. The gaming system where a first one of the at least two different puzzle collection sets includes at least one puzzle that is different from at least one puzzle in a second one of the at least two different puzzle collection sets. The gaming system where the selected puzzle collection includes a plurality of different puzzles. The gaming system where the quantity of puzzle pieces are associated with one of the plurality of different puzzles. The gaming system where displaying the quantity of puzzle pieces in the puzzle collection further includes displaying the quantity of puzzle pieces in the associated one of the plurality of different puzzles. The gaming system further including determining at least two different awards when at least two of the plurality of puzzles of the selected puzzle collection are determined to each include threshold quantities puzzle pieces. The gaming system where the threshold quantity of puzzle pieces includes less than all of the puzzle pieces necessary to fill a puzzle of the select puzzle collection. The gaming system where the threshold quantity of puzzle pieces includes all of the puzzle pieces necessary to fill a puzzle of the select puzzle collection. The gaming system further including determining an award based on the at least one winning symbol combination. The gaming system where the user selection further includes a wager level. Implementations of the described techniques may include hardware, a method or process, or computer software on a computer-accessible medium.

### Gaming System Platform

The features and advantages of the systems and methods described herein may be provided to a player via a gaming system that includes various structures and components for allowing player interaction with the gaming system. While some examples of gaming systems are described in detail herein, it is understood that the features, objects, and advantages of such gaming systems may be implemented in one or more alternative implementations consistent with the present disclosure.

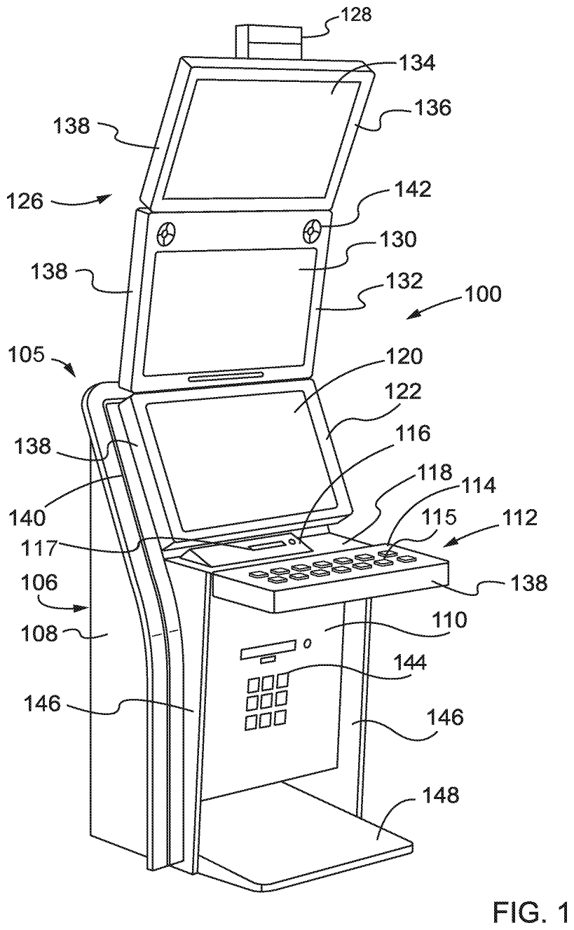

FIG. 1 shows a perspective view illustrating an example of gaming system 100 in accordance with aspects of the present disclosure. The gaming system 100 may be referred to as a slot machine and, as illustrated, includes a cabinet 105 (e.g., a housing) constructed so that a player can operate and play the gaming system 100 while standing or sitting. The cabinet 105 can include a lower cabinet body portion 106, which includes a pair of cabinet side panels 108 (one of which is visible in the perspective view of FIG. 1 and another that is partially visible in FIG. 1), a front panel 110, and a rear panel (not shown). Additionally, a base panel (not shown) and a top panel surface (not shown) may support a first game display device 120 and the player interaction area 112. The cabinet panels 105, 106, 108, 110 (as well as the base panel and the top panel surface) may be interconnected to form the cabinet 105, which encloses and houses components of the gaming system 100. The cabinet 105 may function to securely protect a local game controller and technology components, and to provide support for game display(s) and player input and output systems of the gaming system 100, such as described herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 105, 106, 108, 110 (as well as the base panel and the top panel surface) may be combined into fewer elements or divided into additional elements. Additionally, the positions of the displays (e.g., first display device 120) and input and output devices can be rearranged with respect to one another. In some implementations, the gaming system 100 may include more or fewer components than described herein.

A player can interact with the gaming system 100 in various ways to direct wagering and game activities. The cabinet 105 may include player input systems and output systems generally designated as the player interaction area 112. In some implementations, the player interaction area 112 can be located on the front top side of cabinet 105 and, as shown, on a panel structure that extends outwardly from the gaming system 100 in a player's direction. The player interaction area 112 may contain player input and output systems, including a player control area 114 with one or more input devices 115, a player value acceptor and dispenser area 116, and player convenience input area 118. It should be appreciated that the player interaction area 112 can be placed in other suitable areas of the gaming system 100. In some implementations, the player input and output systems of player interaction area 112 can be positioned in areas apart from each other, such that the player input and output systems are not all contained in a player interaction area 112.

In some implementations, the player control area 114 may include the input devices 115, such as buttons and touch sensitive areas, through with which players may interact with the gaming system 100 to direct game activities. The cabinet 105 can provide an easily accessible location and support for player input and output interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control inputs could be made using physical controls (e.g., hardware buttons, levers, etc.), “soft” controls (e.g., software driven buttons) located on a gaming display and activated by player touch (e.g., touch screen interfaces), motion detection interfaces, etc. It should be appreciated that a player's gaming control inputs can be made using a suitable combination of input devices.

In some implementations, when a player depresses or selects one of the input devices 115, that input device 115 may cause requests, messages, and/or signals to be sent to one or more processors of the gaming system 100. The input devices 115 may be associated with, but are not limited to the following game controls: game selection button(s) (e.g., where more than one game is provided in a single gaming system 100); gaming denomination value selection button(s); wager selection button(s) for the player to indicate or select the desired wager value for a game; pay line selection button(s) for selecting the number of active pay lines in game implementations that provide multiple pay line wagering; reel spin button(s) for players to initiate one or more reels to spin in a game; a repeat last bet button for players to conveniently repeat the last game's preference and wager selections in a new game; a cash-out button for player extraction of available player credits; an attendant call button; and gaming information buttons such as show pay tables, show game rules, or show other game-related information. It should be appreciated that input devices 115 may include other suitable game control inputs.

The player value acceptor and dispenser area 116 may include one or more value acceptance and value distribution devices 117 that allow the player to interact with the gaming system 100 and input value (e.g., money, currency, etc.) to risk or otherwise place a wager (e.g., a monetary value) on one or more outcomes of a game. The value acceptance and value distribution devices 117 may return winnings to the player via some form of value distribution (e.g., currency, paper ticket vouchers, credit on a player tracking card, credit stored in a central database, etc.). In some implementations, in the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

In some implementations, upon receipt of some suitable type of value from the player, the value acceptance and value distribution devices 117 of the player value acceptor and dispenser area 116 can perform validation on the player supplied value using appropriate hardware readers (e.g., determining that the currency bills/coins/tokens/ticket/voucher/card are genuine). If the validation result is positive on player supplied value, the value acceptance and value distribution devices 117 can generate a message/signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player may select an input device 115 associated with a cash out function. The input device 115 may cause a request/message/signal to be sent to a processor of the gaming system 100 to perform a cash out process. The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming system, or converted to currency at a conveniently located kiosk or cashier counter located near the gaming system. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin). In some implementations, the gaming system 100 may update a record of the player's credit meter balance to a remote database.

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, gaming system 100 may include a numeric or alphanumeric keypad (not shown) that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more power charging ports (e.g., universal serial bus (USB) ports, etc.) that enables a player to charge their electronics or connect to services such as the Internet or food service. Further, player convenience input area 118 of the gaming system 100 may include buttons to request food or drink service if the gaming system is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of player device input locations and player device output locations on the cabinet 105 may be dependent upon the game buttons, the type of value wagered, and the player conveniences utilized in the deployment configuration of gaming system 100.

In some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be connected to gaming system 100 and placed in any suitable orientation. In the illustrated implementation, the first game display device 120 can be mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. Although not illustrated, it is understood that some implementations of the gaming system 100 may use a single first game display device 120 and not include additional game displays. For example, a single first game display device 120 may span the one or more portions of the cabinet 105 (e.g., lower body cabinet portion 106 and upper cabinet portion 126, described below) in place of other display devices (e.g., display devices 130 and 134, described below).

The lower cabinet body portion 106 can also support an upper cabinet portion 126. In some implementations, the upper cabinet portion 126 may be comprised of an upwardly extending support structure (not illustrated) that extends upwardly from the rear side of lower cabinet body portion 106 and configured to mechanically support one or more additional game display devices.

Gaming system 100 may include a cabinet top light 128. In some implementations, the cabinet top light 128 is capable of illumination in a variety of colors and can be utilized to indicate and communicate conditions of the gaming system 100 to gaming players and service personnel.

The upper cabinet portion support structure of gaming system 100 may conceal power and communication lines between (1) the control systems and components located within the lower cabinet body portion 106 and (2) the displays mounted on the upper cabinet portion 126 support structure.

In some implementations, as illustrated in FIG. 1, gaming system 100 may include one or more additional display devices, such as a second game display device 130 and/or a third game display device 134. The second game display device 130 and the third game display device 134 can be disposed generally in a vertical relationship and generally in alignment with the first game display device 120. Like the first game display device 120, the second game display device 130 and the third game display device 134 can be LCD display device or other suitable display devices and can be mounted in any suitable orientation in some implementations. Further, like the first game display device 120, the second game display device 130 and/or the third game display device 134 can be mounted within and framed by second display frame 132 and third display frame 136, respectively. The second display frame 132 and the third display frame 136 can be attached to the upper cabinet support structure and can protect the second game display device 130 and the third game display device 134. In some implementations, one or more of the game display devices 120, 130, and 134 may not include a display frame. In some implementations, one or more of the game display devices 120, 130, and 134 can be housed within a same display frame.

In some implementations, the first game display device 120, the second game display device 130, and the third game display device 134 can be disposed at an angle from each other to form a player-facing concave arc. However, in some implementations, the angles between the game display devices 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming system. Equivalent display devices include all variations of liquid crystal displays, light emitting diode displays, and plasma displays.

In some implementations, different sized display devices may be combined to display gaming data on gaming system 100. As a non-limiting example, a 27-inch widescreen LCD display may be combined with a 20-inch portrait-oriented LCD or a light emitting diode (LED) display. The display devices could include organic light emitting diode displays (OLED) or other suitable display devices. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with a game available on gaming system 100.

In some implementations, curved displays may be used for one or more of the display devices on gaming system 100. Similarly, any of the displays used for gaming system 100 can be based on flexible display technologies. For example, it is possible to utilize flexible display technologies to create uniquely shaped curving, wavy, or tubular display structures to provide one or more of the display devices of gaming system 100. Additionally, in some implementations flexible display technologies can be used in combination with fixed flat screen technologies.

While the gaming system 100 has been described as implemented with video technologies, in some implementations, mechanical game reels with reel strips containing game indicia and step motor controllers may be employed to provide game information to a player. In some implementations, the reel strips may include printed symbols. In another implementation, the mechanical game reels may include flexible video display technology as the reel strips on mechanical game reels. Thus, games implemented in video form can readily be implemented with mechanical game reels utilizing such display technology. Alternatively, in other implementations mechanical game reels with reels strips having fixed symbols displayed along the reel strip could be used to implement the game.

Dependent upon a housing style used in some implementations of the gaming system 100, a variety of other display technologies may be utilized in combination with the gaming system disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance meter display. These additional game-related displays may be separate display devices or may be displayed on any one or more of the first game display device 120, the second game display device 130, or the third game display device 134.

The gaming system 100 may also include cabinet lighting that can be used to, among other functions, attract players. In the example gaming system 100 illustrated in FIG. 1, attractive cabinet lighting is provided by frame accent lighting 138. The frame accent lighting 138 can be placed around any number of structures of gaming system 100. For example, the frame accent lighting 138 can be placed around the first display frame 122, the second display frame 132, the third display frame 136, and/or player interaction area 112.

The frame accent lighting 138 may include multiple components. In some implementations, the side edge pieces of the first display frame 122, the second display frame 132, the third display frame 136, and the edge structure of player interaction area 112 can be made of a translucent or transparent plastic or other suitable materials. Linear arrays, or strips, of light emitting diodes (LEDs) (not shown) on circuit boards may be mounted below or on the surface of the side edge pieces. In some implementations, the circuit boards are flexible circuit boards. These LED strips and transparent or translucent coverings may surround one or more gaming system displays frames, as well as the player interaction area, to highlight these areas.

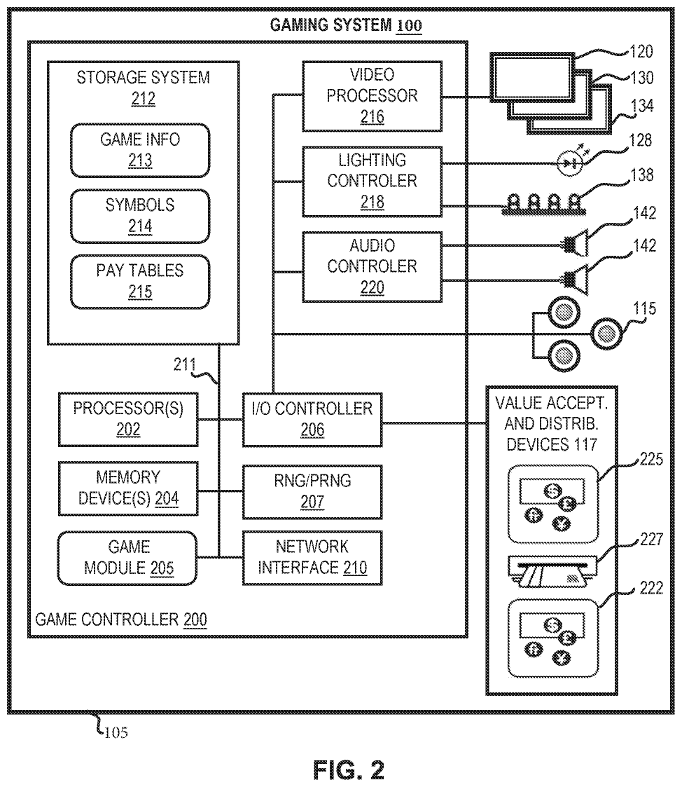

In some implementations, the individual LEDs mounted on the LED strips are of a type that can emit red, green, and blue light. In an alternative implementation, separate LEDs are used for the light colors. In some implementations, the LEDs or LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other suitable variations are possible.

In some implementations, the cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, the cabinet 105 includes cabinet accent lighting 140. In some implementations, the cabinet accent lighting 140 is LED rope lighting mounted flush with the front side edge of the cabinet side panels 108. The LED rope lighting can generate any of suitable colors, and are controlled by cabinet lighting controller and a processor of the gaming system 100 to selectively mix the emitted light colors in a manner to create any color in the same manner as the frame edge lighting.

In various implementations, the gaming system 100 includes one or more audio speakers 142 and appropriate driving electronics and sound cards so that game players may experience pleasing audio aspects of the gaming system 100. Audio is desirable to attract and maintain player interest in the gaming system 100. The gaming system 100 may also emit attraction sounds during any idle period of the gaming system 100. Game audio may add to the player's enjoyment of the gaming system 100 by providing music and sound effects designed to enhance and compliment the gaming experience. In FIG. 1, the audio speakers 142 are shown mounted on the upper corners of the second display frame 132. Any suitable number of additional audio speakers 142 may be provided on additional display frames or on the lower cabinet body portion 106 as desired.

The audio speakers 142 designed for emitting bass vibrations may be included in some implementations. Placement of the audio speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and to block out noise from other gaming systems.

In some implementations, the front panel 110 of the lower cabinet body portion 106 includes a removable panel or door, which can be opened for access to internal control system and technology components that are housed within the lower cabinet body portion 106 (discussed hereinbelow with respect to FIG. 2). The removable panel or door can be locked in some implementations. The front panel 110 may be flanked on vertical sides by cabinet side panel extensions 146 which serve to define a space below the player interaction area 112 for players to place their feet and legs while they are playing the gaming system 100 in a seated position. A foot rest 148, which may be cushioned, can positioned below the player interaction area 112 to enhance a player's ergonomic comfort while playing the gaming system 100. In some implementations, the edges of the player interaction area 112 may be ergonomically cushioned as well.

The gaming system 100 may be constructed using other suitable alternative forms and styles of gaming system housings that are not shown. For example, the cabinet 105 may have fewer or greater number of display devices for displaying games and game-related information to the player. If multiple display devices are used, the display devices may be of similar size, shape, and orientation or the display devices may be divergent from each other in one or more of their respective characteristics. The one or more display devices can be supported by, mounted upon, or contained within the cabinet 105 which can comprise a variety of shapes, sizes, and forms. The cabinet 105 can: protect and house the operational electronics; adequately support the display(s) in a position easily viewable for a seated or standing player, as necessary; and/or provide an easy location and support for all necessary player input/output systems, including gaming control interactions and wagering interactions. For example, in some implementations the gaming system 100 may include a housing style referred to as a “slant top” gaming device that is designed to be operated with the player comfortably seated. In this arrangement, generally, the gaming display(s) and all player input and output controls are located on a low, wide, surface that extends forwardly from the player on a horizontal plane and then slopes upwardly and away from the player's seated location.

In some implementations, housing styles of the cabinet 105 of gaming system 100 may include bar top or table top housing arrangements. These housings are generally small enough to be placed on top of an existing bar or table while providing the requisite gaming system housing functions of protection of/access to gaming electronics, displays, and player input and output functions described above.

In some implementations, the cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 105, one or more player input devices 115, one or more value acceptance and distribution devices 117, one or more display devices 120, 130, and 134, a cabinet top light 128, accent lighting 138, and one or more audio speakers 142, which can be the same or similar to that previously described herein. Additionally, implementations of the game controller 200 may include one or more processors 202, one or more memory devices 204 (e.g., random access memory, read only memory, etc.), one or more game modules 205, one or more input/output (I/O) controllers 206, one or more random number generators 207, one or more network interfaces 210, one or more communication channels 211 (e.g., a data bus), one or more video processors 216, one or more lighting controllers 218, and one or more audio controllers 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions and operations can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for executing one or more games consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 and storage system 212 can be operatively and/or communicatively connected to the processor 202. In some implementations, the memory device 204 and/or the storage system 212 includes one or more types of memory structures. For example, the memory structures can include random access memory (RAMs) units, read only memory (ROMs), flash memory (e.g., solid state drives (SSDs)), electrically erasable/programmable read only memory (EEPROMs), etc. It should be appreciated that in some implementations, communication between the memory device 204, the storage system 212, and the processor 202 or another controller, encompasses the processor or controller accessing the memory device 204 and/or the storage system 212, exchanging data with the memory device 204 and/or the storage system 212 (e.g., reading/writing data to the memory device 204), or storing data to the memory device 204 and/or the storage system 212.

The memory device 204 and/or the storage system 212 may store program code, game code (collectively the “code” or “program instructions,” such as game module 205), and operational data (e.g., game info 213, symbols 214, and pay tables 215, or other suitable data) used in the operations of the game controller 200 to provide a gaming system that executes the gaming functions described hereinbelow. In an alternative implementation, the code and the operational data for the operation of the game controller 200 may be stored in a distributed manner such that some code is stored in memory device 204 (or storage system 212) and other code is stored remotely from the game controller 200. In some implementations, the code and the operational data used the operation of the game controller 200 includes, for example, basic input and output function data, instruction fetching data, bus and network communication protocol data, and like data for an operational gaming system. In some implementations, the code (e.g., the game module 205) and the operational data (e.g., game info 213, symbols 214, and pay tables 215, or other suitable data) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operational data for the operation of the gaming system described above may be stored in the storage system 212. The storage system 212 can be removable game cartridges or flash drives, a compact disk ROM, a digital versatile disk (DVD) optical storage technology, or suitable other fixed, non-transitory computer-readable storage devices. In some implementations, part or all of the code and operational data for operation of the gaming system or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory device 204 may store software components or code that include various game data and game related control and execution software. In some implementations, the software components stored in the memory device 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, the memory device 204 and the storage system 212, with the software components, code, operational data, and other information may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as a processor 202 or a separate ASIC) may execute an authentication routine and perform an authentication of any software component or other data of the game controller 200. In some implementations, the software components of the gaming system 100 and game controller 200 may be prepared for authentication via creation and storage of an encrypted signature unique to one or more of the software components.

In some implementations, an encrypted signature may be created by utilizing a hash function on a software component or code to form a message digest (e.g., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming system software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. In some implementations, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with the gaming system 100, the game controller 200 receives and processes player inputs from, e.g., input devices 115, and the game controller 200 causes processed results to be output or communicated to the player. In some implementations, the player inputs are recognized and processed or directed for processing by input/output (I/O) controller 206. Further, the I/O controller 206 may process and direct player outputs for communication to the player. The I/O controller 206 can function as the intermediary between the processor 202 and one or more input devices to control information and data flow therebetween. The I/O controller 206 may also function as the intermediary between the processor 202 and one or more output devices to control information and data flow therebetween. The I/O controller 206 is configured to understand the communication and operational details (such as hardware addresses) for the attached input devices and output devices. In this manner, processor 202 can be freed from the operational details of the peripheral I/O devices in some implementations. For example, in some implementations where an input or output device is changed or upgraded, the I/O controller 206 can be changed or updated without changing other gaming system components.

In some implementations, a player deposits value into a gaming system by inserting some form of currency or value into a value acceptor 225 for game play. Alternatively, a player deposits value into a gaming system by inserting an encoded paper ticket into a value acceptor 225 for game play in some implementations. The value acceptor 225 can be combined with a currency reader and validator, and a code reader for reading value encoded on paper tickets. In some implementations, the gaming system 100 may include different hardware for the paper ticket reader from the currency reader and validator. The value acceptor 225 may read, validate and communicate the amount of the inserted value to the processor 202. The processor 202 can establish a gaming credit balance for the player based on the communication from the value acceptor 225. The processor 202 can also communicate the player's credit balance on a credit balance meter display of the gaming system 100. During game play, the processor 202 may process a player's wagers and determine an amount of credits to debit from the player's credit balance. When a winning outcome is obtained, the processor 202 is configured to determine an amount of credits to add to the player's credit balance. It should be appreciated that the gaming system 100 may use one or more different processors to perform such calculations.

As previously mentioned with respect to FIG. 1, gaming system may use one or more of a variety of value acceptance systems. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both may be configured with appropriate control instructions to communicate with the value acceptor 225 and extract value from the inserted item containing value. In some implementations, use of a magnetic strip or embedded chip card, for example a bank card, for value insertion requires the processor 202 to communicate, via network interface 210, with devices external to a gaming system 100.

In some implementations, a card reader 227 may be included in gaming system 100 to accept player loyalty cards. For example, the card reader 227 can extract account identifying information from the card and utilizes this information to access the associated account information stored remotely via the network interface 210. In implementations where player loyalty/player tracking systems are used with the gaming system 100, a player's loyalty account and record of gaming activity can be stored in a networked storage location or database. In some implementations, the processor 202 is configured to record the player's gaming activity in the memory device 204 and/or the storage system 212 during the duration of loyalty card insertion. When the loyalty card is removed from the card reader 227, recorded gaming activity is uploaded, via the network interface 210, to the remote storage location associated with the player's account in some implementations. In this manner, the player's gaming activity can be further processed and analyzed, and the player can be awarded loyalty rewards based upon his activity data at the gaming system 100.

In various implementations, the input devices 115 receive a player's game inputs and communicates the player's game inputs to the processor 202. The player's game inputs may include, but are not limited to, wager amounts, pay line selections, game control signals, game selections, and cash-out requests/signals. In some implementations, the input device 115 may generate signals/requests based on button presses, touch screen activations, or voice control. In some implementations, the player-initiated signals can be communicated to the processor 202 by the I/O controller 206. Further, the player-initiated signals may direct and inform execution of the game instructions stored in the memory device 204 and configured to be executed by the processor 202 in some implementations.

In some implementations, the gaming system 100 may include mechanical game reels and other electro-mechanical components to provide game displays and game outcomes (not shown). For example, mechanical game reels (e.g., mechanical game reels rotatable about a common axis) may include indicia or symbols fixedly positioned around the periphery of the mechanical game reels. The indicia or symbols fixedly positioned around the periphery of a mechanical game reel may form a reel strip. The indicia or symbols fixedly positioned on reel strip may comprise a set of symbols for that reel strip or reel. The indicia or symbols on the mechanical game reels are generally associated with separate, detectable reel stop positions. In some implementations, the mechanical game reels can be set into a spinning/rotation motion by pulling a lever or pushing a button of the gaming system 100. In some implementations, the gaming system 100 can stop the game reels by allowing the mechanical game reels to stop naturally, or actuating a suitable mechanical or electro-mechanical reel brake on a random timing basis. When the mechanical game reels stop rotating, the gaming system 100 may, using suitable detection mechanisms, determine one or more displayed stop positions of the mechanical game reels. Since the displayed stop positions of the mechanical game reels can be associated with respective indicia or symbols, the gaming system 100 can determine what combination of indicia or symbols are displayed at the stop positions. The gaming system 100 can also determine whether the displayed indicia or symbols result in one or more winning symbols and/or winning symbol combinations for a game outcome.

In some implementations, the displayed stop positions (e.g., corresponding to displayed indicia) can be determined using random numbers associated with the displayed stop positions/indicia/symbols of the mechanical reels. In some implementations, the processor 202 is configured to execute stored program code and instructions which generate random numbers or pseudo-random numbers for determining the displayed stop positions of the mechanical reels. The gaming system 100 can use the randomly generated numbers to determine which stop positions of the reels should be displayed for a game outcome.

In some implementations, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming system 100 during game execution. In some implementations, the gaming system 100 can utilize the random numbers for the random selection of one or more symbols (e.g., stop positions) along mechanical game reels.

In some implementations, the gaming system 100 uses video-based reels as simulations of the mechanical reels to provide game displays of game outcomes. In some implementations, the video-based reels are used in place of mechanical reels. In some implementations, the video-based reels are used in conjunction with mechanical reels or other mechanical components. Like a mechanical game reel, a video-based reel can be associated with a reel strip, where the reel strip includes a set of symbols or indicia. The set of symbols or indicia for a reel strip may be fixed or dynamic in various implementations. In some implementations, indicia or symbols can include, but are not limited to, numbers, letters, geometric figures, symbols, images, characters, animations, blank symbols (e.g., the absence of symbols), or any other suitable graphical depiction. The gaming system 100 may include one or more video-based reels for a game. The gaming system 100 may include a particular reel strip associated with a particular video-based reel. In some implementations, each video-based reel can be associated with a separate reel strip (e.g., a separate set of symbols). The reel strips can be the same or different for different video-based reels. It should be appreciated that the language “reel strip(s)” is used merely for illustration purposes throughout this disclosure. In some implementations, predetermined reels strips may be used. In other implementations, a reel strip is a representation of a set of symbols, where symbols in the set of symbols are associated with a probability of being determined or generated for display in the visible symbol display areas of a video-based reel. Different reel strips (e.g., different sets of symbols) may include the same symbols associated with the same or different probabilities of being determined or generated. In some implementations, different reel strips may include different symbols. It should be appreciated that in some implementations, indicia or symbols can be used independently of a video-based reel. That is, some games on gaming system 100 may not use video-based reels or reel strips, but use random number determinations for game outcomes.

Returning to random number generation, symbols in the reel strips or sets of symbols can be associated with numbers for video-based reels similar to mechanical game reels. In some implementations, when the RNG 207 selects a number, a processor in conjunction with the memory devices 204 of the gaming system 100 can correlate the selected number to an associated symbol to determine what symbol has been randomly selected. In various implementations, once symbols are randomly selected based upon the random numbers generated by the RNG 207, the processor 202 can evaluate the displayed patterns of symbols or randomly determined numbers to determine one or more game outcomes. It should be appreciated that in some implementations, gaming system 100 may include a hardware based random number generator that is in communication with processor 202 to supply random numbers for random game symbol determination purposes. The hardware based random number generator may be incorporated into the processor 202 or can be separate from the processor 202.

Returning to FIG. 2, the game controller 200 controls the function and output of output devices utilized by a gaming system. In various implementations, the I/O controller 206 serves as an interface unit between the processor 202 and output devices, such as video processor 216, cabinet lighting controller 218, audio controller 220, and value dispenser 222.

In some implementations, the video processor 216 communicates with the processor 202 to render at least some of the game graphics, video displays, and information on one or more video display devices (e.g., game display devices 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing symbol sets.

It should be appreciated that in certain other implementations where gaming system 100 includes physical mechanical game reels to display game symbols or other game features, reel controllers and stepper motors can be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with the gaming system 100.

In various implementations, players may request their remaining credit value by selecting one of the input devices 115, which in turn makes a request or initiates a signal that is communicated to the processor 202, such as via the I/O controller 206. In some implementations, the signal triggers a readout of the player's credit balance from a credit balance meter and the processor 202 initiates a value dispensing signal which, in turn, can be communicated to the value dispenser 222. In some implementations, the value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player. It should be appreciated that any suitable combination of forgoing may be available at gaming system 100.

In some implementations, the game controller 200 may communicate with one or more devices outside the gaming system 100. For example, gaming system 100 may be connected to a larger network via a local area network (LAN) or a wide area network (WAN). The game controller 200 may communicate with one or more central servers, controllers, or remote devices to execute games, establish credit balances, participate in progressive jackpots, etc. In some implementations, network communications and connections can be accomplished via a network interface 210. Network interface 210 can be a digital circuit board or card installed in game controller 200 to provide network communications with external devices. Network interface 210 may include wired and/or wireless communication hardware.

In some implementations, various additional features and functions are performed by the game controller 200. For example, the game controller 200 may be specially configured with software to track game play events that occur on the gaming system 100. In some implementations, the game controller 200 may audit recorded monetary transactions, including wager amounts, game outcomes, game winnings, and game payouts that occur through the value dispenser 222. Further, some implementations of gaming system may include security software to assist in protecting the gaming system 100 from tampering or alteration attempts.

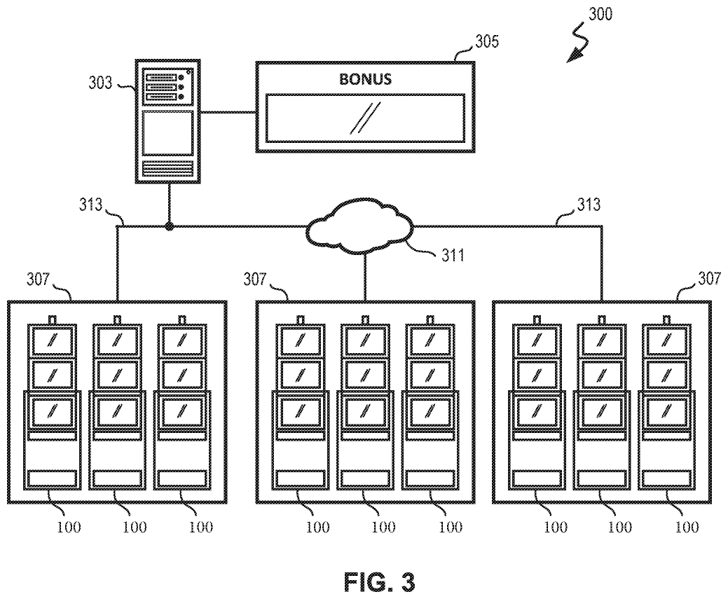

FIG. 3 illustrates an example of an environment 300 for implementing systems and methods in accordance with an implementation of the present disclosure. The environment 300 includes a bonus server 303 and a bonus display 305 that are functionally connected with one or more banks 307 of one or more gaming systems 100 via a network 311 and one or more wired or wireless communication links 313. The bonus server 303 can be one or more computing devices comprising hardware, software, or a combination thereof that manages bonus games provided by the gaming systems 100 of one or more of the banks of gaming systems 307. In some implementations, the bonus server 303 functions to collect and maintain funds for one or more bonuses, display the values of the bonuses using the bonus display 305, and provide the bonuses to the gaming systems 10. For example, the bonus server 303 can maintain different pools of funds corresponding to different bonus levels (e.g., small, large, and grand/jackpot bonuses). In some implementations, the bonuses can be progressive bonuses in which the bonus server 303 incrementally accumulates the pools from wagers made at the gaming systems 100.

The bonus display 305 can include one or more display devices that display values of the bonuses managed by the bonus server 303. The bonus display 305 can be a video display or a mechanical display device. For example, the bonus display 305 can be a cathode ray tube (CRT) display, a liquid crystal display (LCD), a light-emitting diode (LED) display, a flip card display, a reel display, etc. The bonus display 305 may be located so as to be viewable by players of the gaming systems 100 in a same location or a same bank 307. In some implementations, the banks 307 of gaming systems 100 can be collocated within view of the bonus display 305. While FIG. 3 shows a single bonus display 305, it is understood that the environment 300 can include more than one bonus display 305. In some implementations, multiple bonus displays 305 may be used, such as when some of the banks 307 are at different physical locations. In some implementations, the individual gaming systems 100 can include respective bonus displays 305. For example, the gaming systems 100 can include respective top displays (e.g., display device 134 in FIG. 2) repeating the function and information provided by the bonus displays 305. The bonus displays 305 connected to the network 311 may have substantially the same information displayed. For example, while individual banks 307 or the gaming systems 100 may have different games or themes, such banks 307 and the gaming systems 100 may participate in bonus games having a common bonus pool that is managed and paid out by the bonus server 303 based on certain game features occurring.

The banks 307 can include two or more of the gaming systems 100 that may be at the same or different locations as the bonus server 303 or one another. The locations can be different spaces within a single facility (e.g., casino, airport, or mall) or in spaces at separate locations. In some implementations, a bank 307 may include a single gaming system 100.

The network 311 can be a wired or wireless computer network that functions to exchange information between the bonus server 303 and the gaming systems 10. The network 311 can be, for example, a peer-to-peer network, a local area network, a wide area network, or the Internet. The network 311 may be located in a single location or spread over multiple locations and may be connected to other networks.

The gaming systems 100 in the network 311 may include displays for a main game and a bonus game (e.g., game display devices 120, 130, and 134). The bonus game may be common to the gaming systems 100, while one or more of the gaming systems 100 may provide different base games. The bonus may be provided when certain criteria at one of the gaming systems 100 are achieved in the bonus game. The criteria may be, for example, the display of a particular symbol or symbol combination, or a particular outcome of the bonus game.

In some implementations, the gaming systems 100 may participate in multiple bonus games having respective bonus awards. For example, a first bonus may be available when the player makes a small wager, a second, larger bonus may be available when the player makes a larger wager, and a third, still larger bonus may be available when the player makes an even larger wager. It understood, however, that the different bonus levels available may not be associated with wagers of a player. Instead, for example, all of the different bonus levels may be available to the player and the award of a particular level may correspond to the outcome of the bonus game.

### Gaming System Operation

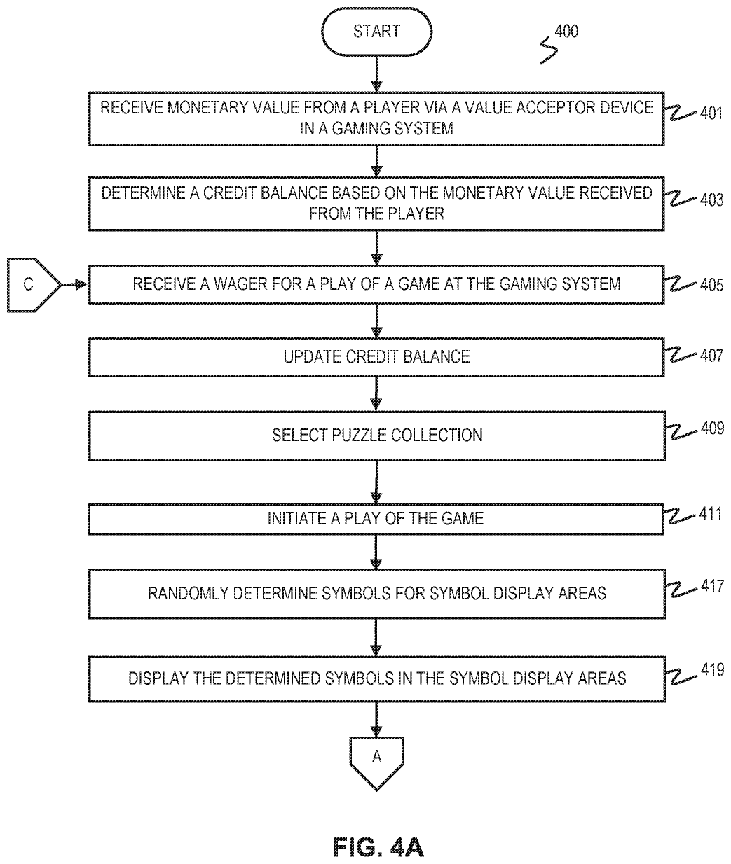

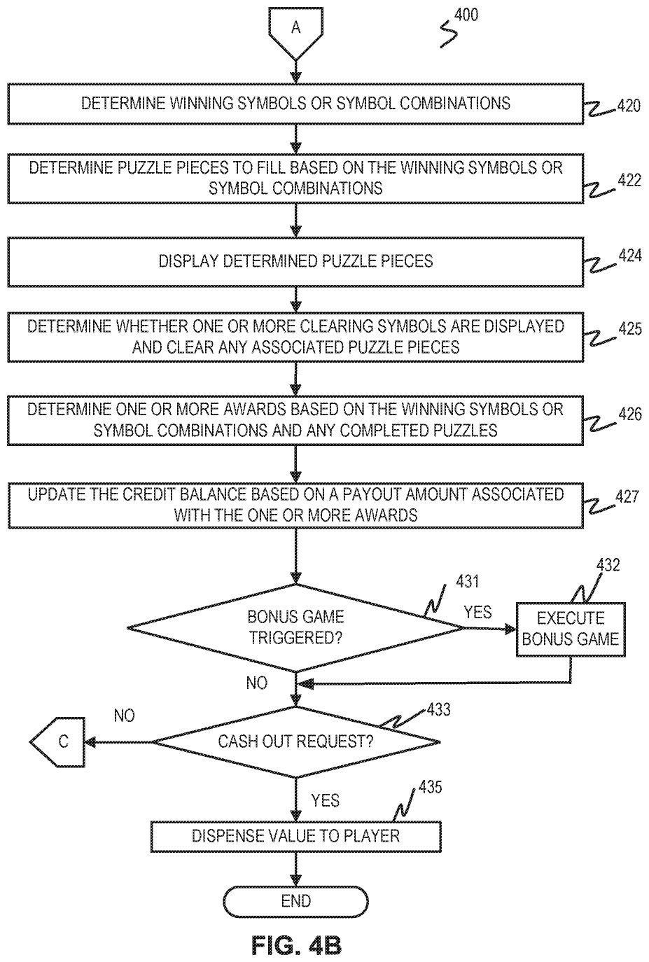

The flow diagrams in FIGS. 4A and 4B illustrate functionality and operations of systems, devices, processes, and computer program products according to various implementations of the present disclosure. Each block in FIGS. 4A and 4B can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 4A and 4B. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions.

FIGS. 4A and 4B show a process flowchart illustrating an example of a method 400 of operating a gaming system (e.g., gaming system 100) in accordance with aspects of the present disclosure. FIGS. 4A and 4B describe parts of a game, including a first part of the game and a second part of the game that may be enabled by events in the first part of the game. In some implementations, the first part of the game is a base or primary game and the second part of the game is a bonus game that may be triggered from events in the base game. However, it is understood that FIGS. 4A and 4B may be integrated as a single game in which the elements of the second part of the game occur in the first part of the game. In some implementations, the gaming system includes a puzzle pieces collection game, wherein the player attempts to obtain puzzle pieces to form a partial or complete image from the separate puzzle pieces. In some implementations, one or more processors (e.g., processor 202) of the gaming system are configured, via instructions (e.g., gaming module 205) stored in a memory device (e.g., memory device 204 or storage system 212) to perform the method 400.

In some implementations, a play of a game begins when the gaming system receives a monetary value from a player (e.g., block 401). In other implementations, a play of the game begins when the gaming system receives a wager (e.g. block 405). In some implementations, a play of the game can start after block 431, without being triggering by any primary game or base game. The play of the game can end when the first part of the game is complete and a second part of the game is not triggered or otherwise initiated (e.g., block 431, “No”). In some implementations, the play of the game can also end when the gaming system receives a request to cash out (e.g., block 433, “Yes”). In some implementations, blocks 433 and 435 are not part of a play of a game. In alternative implementations, blocks 433 and 435 are part of a play of a game.

Turning to block 401 in FIG. 4A, the gaming system (e.g., gaming system 100) performing the method 400 receives a monetary value via a value acceptor device (e.g., value acceptor 225) in block 401. In block 403, the gaming system determines a credit balance based on the monetary value received in block 401. In block 405, the gaming system receives a wager for a play of a game from a player via an input device (e.g., input device 115) using, e.g., the credit balance determined at block 403. In some implementations, the gaming system allows the player to place a minimum wager, a maximum wager, or other suitable wager therebetween. Also, in some implementations, an amount of the wager may determine the value of some of the awards available from the game. In some implementations, the gaming system determines whether the credit balance determined at block 403 includes enough credits to enable the wager received at block 405. The gaming system may prevent the player from placing the wager and initiating play of a game if the credit balance determined at block 407 is not large enough to support the wager. If enough credits are not available in the player's credit balance, the gaming system may provide the player with an option to insert additional value to obtain the minimum credit level or to cash out of the gaming system. A cash out request may trigger the gaming system to issue a cash out request or signal to a value dispenser.

In some implementations, the wager received at block 405 funds one play of a game, whereas a player's credit balance may permit multiple plays of a game for a gaming session. In some implementations, the gaming system starts a gaming session in response to receiving monetary value from a player (e.g., at block 401) and ends when a player cashes out of a gaming system or the player's credit balance is below a minimum wager amount (e.g., zero or other suitable number) and the player does not replenish their credit balance. A gaming session at a gaming system may include zero plays of a game or multiple plays of a game or multiple plays of different games (e.g., where a gaming system includes multiple different games to play).

At block 407, the gaming system updates the credit balance determined at block 403. In some implementations, the credit balance is updated based on the amount of the wager received at block 405. It is understood that some implementations of the method 400 may not include block 407 and that the gaming system may update player's credit balance at other times, such as at the completion of the game.

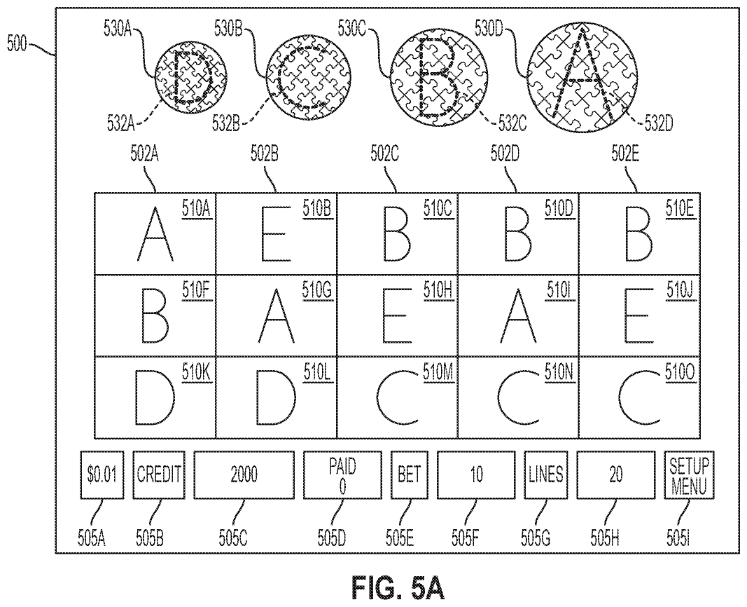

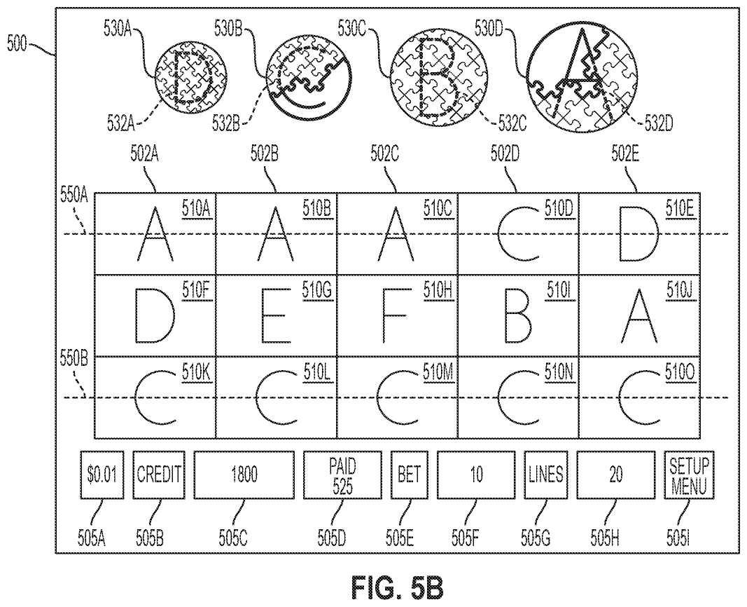

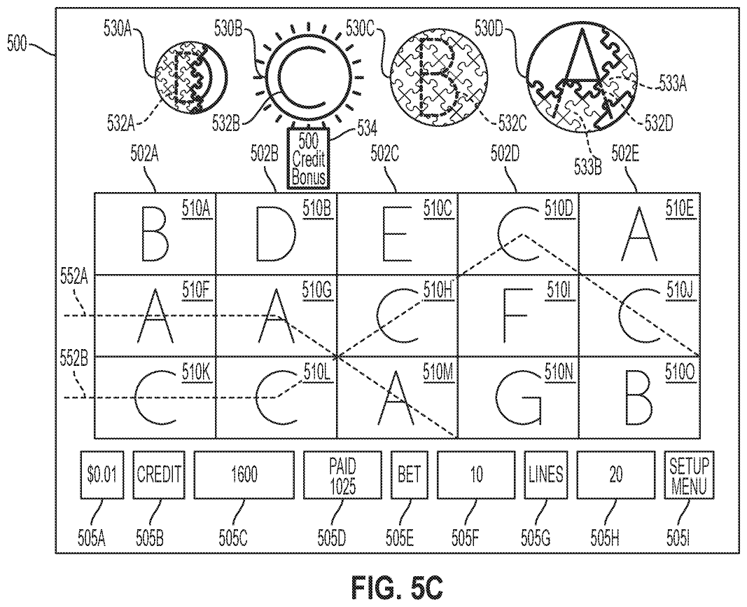

In some implementations, depending on the amount of the wager received at block 405, the gaming system enables the player to select particular pay lines across reel symbol positions displayed in a game screen (e.g., symbol display areas 510A-510O on game reels 502A-502E of game screen 500 in FIGS. 5A-5C). Although in some implementations, the gaming system selects the active pay lines automatically based on the wager received at block 405. It is understood that some implementations of the gaming system may not include pay lines and, as such, the method 400 may not perform any pay line selections. For example, the gaming system may use ways-pays (e.g., all-ways pays) as an alternative to pay lines. It is further understood that some implementations may use “ways-pays” or “ways to win” as an alternative or in combination with the activated pay lines. In some implementations, ways-pays determines wins based on every possible combination in a slot machine game. For example, a five-reel slot machine with three visible symbols display areas on a reel can have 243 different pay lines, which can be all possible combinations when evaluating symbols from the left reel to the right reel. In some implementations, ways-pays can be viewed as being independent of pay lines or including all possible pay lines. In some implementations, with ways-pays, a player can win based on any winning combination from left to right. In some implementations, additional ways-pays are available where a gaming system evaluates symbols from left to right or right to left. Ways-pays can alternatively be understood as all the symbols being evaluated as combinations of scatter symbols, where a scatter symbol is a symbol that triggers a payout regardless of whether the scatter symbol appears on a pay line.

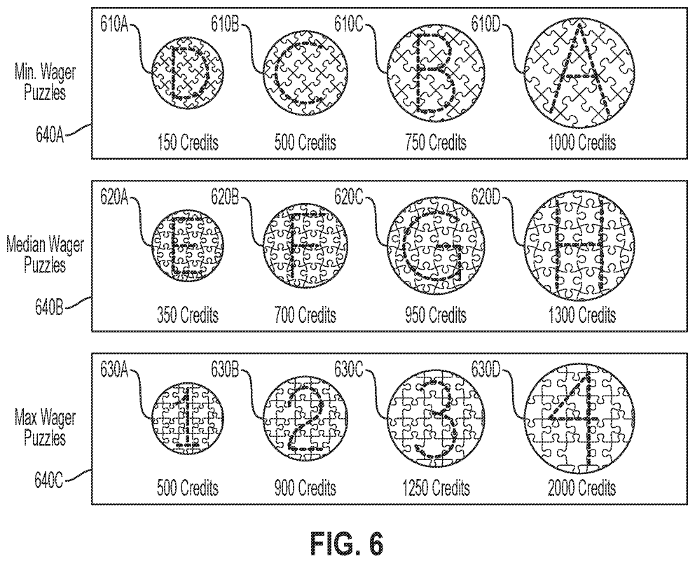

In some implementations, the gaming system includes one or more puzzles. In some implementations, a puzzle is formed from one or more puzzle pieces. In some implementations, when the one or more puzzle pieces that form a puzzle are grouped together, the grouped puzzle pieces represent a coherent image. In some implementations, the image formed from the puzzle pieces that are grouped together is different from an image of an individual puzzle piece. The image can be any suitable image. For example, in an ancient Egyptian themed game, a puzzle may include an image of an ancient Egyptian artifact. Other suitable themes and other suitable images can be used for puzzles. In some implementations, the images used for a puzzle can include, but are not limited to, numbers, letters, geometric figures, symbols, images, characters, blank symbols (e.g., the absence of symbols), animations, transparent symbols (e.g., symbols that permits underlying symbols to be visible), or any other suitable graphical depiction. In various implementations, the shapes of the puzzle pieces can be any suitable shape. As shown in FIG. 6, the puzzles (e.g., puzzle 610A, 620B, 630D) include puzzle pieces that are shaped like jigsaw puzzle pieces. In other implementations, the puzzle pieces can be formed in other suitable shapes. In some implementations, different puzzles can use different shapes.

In some implementations, the quantity of puzzle pieces to needed to complete a particular puzzle may vary. In some implementations, a player can obtain the puzzle pieces over one or more plays of a game. In some implementations, the gaming system provides the player with puzzle pieces based on the gaming system generating winning symbols or winning symbol combinations. For example, generating a winning symbol combination of four Cherry symbols may cause the gaming system to provide the player with three puzzle pieces that are associated with a puzzle that partially forms or reveals a Cherry symbol in some implementations. In some implementations, the quantity of puzzle pieces that the gaming system provides to a player for a winning symbol or winning symbol combination may vary based on several different factors, such as a player's wager, random determination, etc.

In some implementations, puzzle pieces obtained for a particular puzzle will remain with the particular puzzle for one or more plays of a game. In some implementations, a puzzle may retain puzzle pieces between different gaming sessions. For example, a first player in a first gaming session may obtain five puzzle pieces for a particular puzzle. If the player does not obtain an award for the particular puzzle and ends the gaming session, the gaming system may retain the five puzzle pieces for one or more next players and one or more next gaming sessions in some implementations. It should thus be appreciated that a second player may benefit from puzzle pieces that a first player collected.

In some implementations, a puzzle is associated with an award. In some implementations, to obtain an award associated with a puzzle, the player completes the puzzle (e.g., puzzle 530B in FIG. 5C) or otherwise obtains a threshold quantity of puzzle pieces for the puzzle during a play of a game. In some implementations, a threshold quantity of puzzle pieces can be a fixed number of puzzle pieces for a puzzle (e.g., obtaining 10 puzzle pieces) or a percentage of the total number of puzzle pieces for a puzzle (e.g., obtaining 75% of the puzzle pieces). In some implementations, a threshold quantity of puzzle pieces can comprise obtaining puzzle pieces that reveal a complete image, but not require puzzle pieces that do not include a coherent image displayed in the puzzle (e.g., puzzle 530D of FIG. 5C includes puzzle pieces 533A and 533B that do not include the “A” image). In some implementations, different puzzles can be associated with different thresholds of puzzle pieces that are necessary to win an award associated with a respective puzzle. In some implementations, the player can complete more than one puzzle in a play of a game to obtain more than one award associated with respective completed puzzles. In some implementations with a plurality of puzzles, the gaming system may include different awards associated with different puzzles. In some implementations, some of the awards for some puzzles can be the same. In various implementations, the awards associated with a puzzle can be any suitable award. In some implementations, an award associated with a puzzle is a credit award. Other suitable awards (e.g., free games, free spins, wild symbols usable in a future game, meal vouchers, etc.) can be associated with a puzzle.

In some implementations, the gaming system groups one or more puzzles in a puzzle collection set. In some implementations, puzzles in a puzzle collection set can be the same or different puzzles. For example, for a puzzle collection set with two puzzles, the puzzles may be different puzzles. In some implementations, the different puzzles in a puzzle collection set can have the same or different quantities of puzzle pieces to complete the puzzles. One or more of the puzzles of a puzzle collection set can be associated with the same or different awards. In some implementations, puzzles in a puzzle collection set can be formed in a same, similar, or different shape when complete. For example, in some implementations, the puzzles in a puzzle collection set can be formed in a circle shape. In other examples, the puzzles in a puzzle collection set can be formed in a rectangular, triangle, or other suitable shape. In some implementations, different puzzles in a puzzle collection set can be formed into different shapes. In some implementations, one or more puzzles in a puzzle collection set can be different sizes from other puzzles in the puzzle collection set. For example, in some implementations, a puzzle associated with a large award can be a larger visual size than a puzzle associated with a smaller award. For example, puzzle 610D in FIG. 6 associated with a 1000 credit award is visually larger than puzzle 610A associated with a 150 credit award. In some implementations, the shapes of the puzzle pieces may be the same in different puzzles in a puzzle collection set. In some implementations, the shapes of the puzzle pieces may be different in different puzzles in a puzzle collection set. In some implementations, a puzzle associated with a large award can include a larger quantity of puzzle pieces than a puzzle associated with a smaller award.

In some implementations, the gaming system includes a plurality of puzzle collection sets. The plurality of puzzle collection sets can include any suitable quantity of puzzle collection sets. For example, the plurality of puzzle collection sets can include two puzzle collection sets. In some implementations, the plurality of puzzle collection sets can include three, four, or any suitable quantity of puzzle collection sets. One puzzle collection set can include different puzzles from another puzzle collection set. Such an example is illustrated in FIG. 6, where puzzle collection set 640A includes different puzzles 610A, 610B, 610C, and 610D than puzzle collection set 640B. In some implementations, different puzzle collection sets can be associated with different awards. In some implementations, one or more puzzle collection sets may be associated with higher valued awards than other puzzle collection set. In some implementations, some puzzles in different puzzle collection sets can be associated with the same awards.

In some implementations, one or more of the puzzle collection sets is associated with a minimum or threshold wager level. For example, in some implementations, to access the puzzle collection set 640C in FIG. 6, a player places a maximum wager on a play of a game. Placing a maximum wager may also enable a player access to the puzzle collection set 640B and to puzzle collection 640C. In some implementations, where the player places a minimum wager, the gaming system may permit the player to access the minimum wager puzzles 640A, but not the median wager puzzle collection set 640B or the maximum wager puzzle collection set 640C. In some implementations, the player can access different puzzle collection sets in different plays of a game. For example, a player may access the puzzle collection set 640A for one or more plays of the game and then switch to either puzzle collection sets 640B or 640C for one or more subsequent plays of the game. In some implementations, the gaming system permits the player to switch between different puzzle collection sets in each next play of the game. In some implementations, the gaming system allows the player to obtain puzzle pieces for different puzzles and these puzzle pieces are stored in the puzzle for one or more plays of the game. For example, in some implementations, a player can obtain some of the puzzle pieces for puzzle 610A in puzzle collection set 640A in FIG. 6 for one or more plays of a game. The player can then switch to obtaining puzzle pieces for the puzzles in puzzle collection set 640B for one or more plays of the game. In some implementations, the player can switch back to the puzzle collection set 640A in FIG. 6 and the previously obtained puzzle pieces are still available for additional plays of the game. If the player ends a gaming session and a second player starts a new gaming session at the gaming system, the gaming system may enable the second player (or an nth player) to use the previously obtained puzzle pieces from the prior play in the second player's plays of the game. In some implementations, one or more puzzles are cleared after a predetermined number of plays of a game and the puzzle has not been completed.

Returning to the method 400, as shown in the block 409, where a gaming system includes a plurality of puzzle collection sets, the gaming system may select a puzzle collection set. In some implementations, the gaming system, randomly selects one of the puzzle collection sets to display for a play of a game using a random number generator. In some implementations, the gaming system may select a puzzle collection set based on a player input. In some implementations, the gaming system receives a player input that results in a selection of one puzzle collection set from the plurality of puzzle collection sets for a play of a game. In some implementations, the gaming system displays a plurality of puzzle collection sets to the player and enables the player to select a puzzle collection set from the plurality of puzzle collection sets. In some such implementations, the puzzle collection sets are associated with a minimum wager level that a player makes to obtain the selected puzzle collection set for the play of the game. In some implementations, if the player's wager in block 405 was below the minimum wager level associated with the selected puzzle collection set, the gaming system may require the player to increase the wager level to the minimum wager level associated with the selected puzzle collection set. In some implementations where the player's wager level is below the minimum wager level for the player's selected puzzle collection set, the gaming system may allow the player to select another puzzle collection set. In some implementations, the player places a wager at the gaming system and the gaming system uses this player input to determine which one of the puzzle collections sets to select from the plurality of puzzle collection sets based on the player's wager. For example, the gaming system may select a puzzle collection that is associated with a minimum wager level that is equal to or lower than the player's wager.

In some implementations, selection of a puzzle collection set causes the gaming system to display the selected puzzle collection set that is incomplete. In some implementations, the puzzle collection set is displayed as incomplete or partially complete. For example, as shown in FIG. 5A, an outline of a selected puzzle collection set is displayed as 530A, 530B, 530C, and 530D. In some implementations, as puzzle pieces are collected for the respective puzzles of the puzzle collection set, the puzzle pieces are displayed in their appropriate locations in the outline of the puzzles (as will be described further below).

At block 411, the gaming system initiates a play of the game. The initiation can be automatically triggered in response to the wager at block 405 or it can be manually triggered in response to receiving an input via an input device. For example, for a game that includes video-based reels, the player may press a spin button on the gaming system (e.g., input device 115) or actuate a lever to start spinning the video-based reels of the gaming system (or randomly generating symbols using other methods) for the play of the game.

It should be appreciated that video-based reels, reels, slot machine reels, gaming reels, etc. used throughout the specification may refer to mechanical reels, electro-mechanical reels, or video reels. It should further be appreciated that although many examples illustrated in the specification describe the gaming system in terms of slot machines with reels, other gaming systems may be used, including gaming systems without reels.

At block 417, the gaming system randomly determines, using a random number generator (e.g., random number generator 207), symbols for a base game from one or more symbol sets. In implementations in which the game reels are rendered using a video display (e.g., display 120), the random number generator can be used to select the symbols from the one or more symbol sets (e.g., sets comprising game symbols 214). As non-limiting examples, the symbol sets can include graphical indicators depicting numbers, letters, geometric figures, playing cards, images, characters, animations, blanks (e.g., the absence of symbols), or the like. Additionally, the symbols sets may include modifier symbols, such as cash award symbols (e.g., 100 credits or $10) and award multiplier symbols (e.g., a 10× increase in an award of a winning combination). Further, the symbol sets may include special or designated symbols (e.g., wild symbols, trigger symbols, scatter symbols, collectable symbols, free game symbols, etc.). In some implementations, types of symbols included in the symbol sets may be different. While the reels above are described as being rendered by a video display, it is understood that some implementations may instead use mechanical or electro-mechanical game reels to select symbols by physically rotating to a randomly-selected stop position.

In some implementations, one or more of the symbols in the symbol sets are associated with generating puzzle pieces. For example, in an ancient Egyptian themed game, a Sphinx symbol can be associated with generating one or more puzzle pieces for a Sphinx puzzle or for a pyramid puzzle. The gaming system may be configured to generate a certain quantity of Sphinx puzzle pieces (e.g., four puzzle pieces or some other suitable number of puzzle pieces) when a winning symbol combination of Sphinx symbols are generated in symbol display areas of the game. In some implementations, one or more of the symbols in the symbol sets can be designated as a puzzle clearing symbol. A puzzle clearing symbol is described in more detail below.

At block 419, in some implementations, the gaming system causes a display device (e.g., game display device 120) to display the randomly determined symbols determined at block 417. For example, in some implementations in which reels are rendered using a video display, the gaming system may populate visible symbol display areas displayed on one or more reels displayed in the game.

Turning to FIG. 4B, as indicated by off-page connector “A,” at block 420, the gaming system determines winning symbols and/or winning symbol combinations of the displayed symbols in the symbol display, if any. In some implementations, the gaming system evaluates the displayed symbols across (e.g., across active or wagered pay lines and/or based on ways pays) for winning symbols or winning symbol combinations. In some implementations, the gaming system evaluates the winning symbol combinations based on the pay lines wagered upon by a player, ways-pays, scatter symbols, or other suitable evaluation criteria. The gaming system may evaluate the player-selected pay lines, gaming system assigned pay lines, or pay lines assigned as active in some other manner for the play of the game. In some implementations using reels, the gaming system determines an award based on winning symbols or winning symbol combinations displayed across the reels on active pay lines. For example, if a pay table associated with the gaming system indicated that at least three of the same Cherry symbols is a winning symbol combination on an active pay line and results in a predetermined award, the gaming system may evaluate the determined and displayed symbols for groupings of at least three Cherry symbols. If the gaming system determined and displayed at least three Cherry symbols on adjacent reels and along an active pay line, the gaming system may determine that the three Cherry symbols is a winning symbol combination based on the pay table. It should be appreciated that a pay table may include any suitable number of different winning symbols and/or winning symbol combinations and associated awards. In some implementations, a pay table may indicate that as few as one symbol may be associated with an award. Alternatively, any suitable two or more symbols may be used to form winning symbol combinations that result in an award. It should be appreciated that in some implementations, the gaming system may determine winning symbols and/or winning symbol combinations prior to the determined symbols in block 417 being displayed in block 419.

In some implementations, as illustrated in block 422, the gaming system determines, based on winning symbols or winning symbol combinations, puzzle pieces to add to incomplete puzzles that were selected in block 409. In some implementations, a winning symbol can cause the gaming system to generate one or more puzzle pieces to add to a displayed puzzle. In some implementations, the gaming system generates one or more puzzle pieces to add to a displayed puzzle in accordance with certain winning symbol combinations. For example, in some implementations, the gaming system may be configured to generate a first quantity of puzzle pieces for a winning symbol combination that includes three symbols, generate a second quantity of puzzle pieces for a winning symbol combination that includes four symbols, and generate a third quantity of puzzle pieces for a winning symbol combination that includes five symbols. In some implementations, the third quantity of puzzle pieces is larger than the first quantity of puzzle pieces and the second quantity of puzzle pieces. For example, the third quantity of puzzle pieces may be seven puzzle pieces or some other suitable number. In some implementations, the second quantity of puzzle pieces is larger then the first quantity of puzzle pieces and less than the third quantity of puzzle pieces. For example, the second quantity of puzzle pieces may be five puzzle pieces or some other suitable number and the first quantity of puzzle pieces may be three puzzle pieces or some other suitable number. In some implementations, the gaming system does not generate puzzle pieces unless the gaming system determines that a winning symbol combination includes more than a predetermined quantity of symbols (e.g., four or more symbols).

In some implementations, symbols in a winning symbol combination are associated with one puzzle and therefore cause the gaming system to generate puzzle pieces for one puzzle. In some implementations, symbols in a winning symbol combination are associated with one or more puzzles and can cause the gaming system to generate puzzle pieces for more than one puzzle.

In block 424, in some implementations, the gaming system displays the generated puzzle pieces in their appropriate associated puzzles. In some implementations, the gaming system automatically places generated puzzle pieces into puzzles that are associated with the puzzle pieces. The gaming system can match puzzle pieces with appropriate puzzles, orient puzzle pieces appropriately, and display the puzzle pieces in the puzzles. In some implementations, the gaming system may enable the player to place puzzle pieces in appropriate puzzles. In some implementations, the gaming system generates puzzle pieces in an area of the game screen and enables a player to drag one or more puzzle pieces to their appropriate puzzle (e.g., through a touch screen or other suitable input device). In some implementations where the player places puzzle pieces in puzzles, the gaming system properly orients and displays puzzle pieces in a puzzle once the player drags the puzzle to the appropriate puzzle. In some implementations where the player places puzzle pieces in puzzles, the gaming system enables the player to properly orient and place puzzle pieces in an appropriate puzzle. Thus, it should be appreciated that in some implementations, one or more puzzles may include skill to place puzzle pieces while the gaming system can automatically place puzzle pieces in one or more puzzles.

In some implementations, the gaming system may generate a puzzle clearing symbol. In some implementations, the gaming system may determine whether the determined symbols in block 417 included a puzzle clearing symbol, as is illustrated in block 425. In some implementations, when the gaming system generates a puzzle clearing symbol during a play of a game, the gaming system may clear or remove obtained puzzle pieces from one or more puzzles. In some implementations, a puzzle clearing symbol may clear a determined quantity of puzzle pieces from one or more puzzles. For example, a puzzle clearing symbols may clear two, three, or some other suitable quantity of puzzle pieces from one or more puzzles. In some implementations, a puzzle clearing symbol may cause the gaming system to clear all of the puzzle pieces in one or more puzzles. In some implementations, different puzzles in a puzzle collection set are associated with different puzzle clearing symbols. For example, a first puzzle can be associated with a first puzzle clearing symbol and a second puzzle can be associated with a second puzzle clearing symbol. In some implementations, where the gaming system generates a second puzzle clearing symbol during a play of the game, the gaming system clears one or more puzzle pieces from the second puzzle (e.g., where the second puzzle includes obtained puzzle pieces) but does not clear the first puzzle of obtained puzzle pieces. As another example, in some implementations, where the gaming system generates a first puzzle clearing symbol during a play of the game, the gaming system clears one or more puzzle pieces from the first puzzle (e.g., where the first puzzle includes obtained puzzle pieces) but does not clear the second puzzle of obtained puzzle pieces.

At block 426, in some implementations, the gaming system determines one or more awards based on the winning symbols or winning symbol combinations determined at block 420. In some implementations, the gaming system also determines whether any puzzles are complete. If the gaming system determines that a puzzle is complete (e.g., includes all or a threshold quantity of puzzle pieces to form the puzzle), the gaming system may provide the player with an award for the completed puzzle in some implementations. The gaming system may provide a separate award for each puzzle that is completed. In some implementations, the gaming system may determine if any puzzles contain a threshold quantity of puzzle pieces. In some implementations, the threshold quantity of puzzle pieces can be less than all puzzle pieces (e.g., less than all puzzle pieces that are needed to form the puzzle). In some implementations, the gaming system may provide the player with an award for obtaining a threshold quantity of puzzle pieces in a puzzle. In some implementations, the gaming system may provide separate awards for multiple puzzles that obtain a threshold quantity of puzzle pieces. In some implementations, the award for obtaining a threshold quantity of puzzle pieces can be the same award as completing the puzzle. In some implementations, the award for obtaining a threshold quantity of puzzle pieces can be lower than the award for completing the puzzle. In some implementations, where an award is available for obtaining a threshold quantity of puzzle pieces in a puzzle, the gaming system may provide the player an opportunity to select an award for the puzzle or reject the award in an attempt to obtain more puzzle pieces for the puzzle in one or more next plays of the game and thereby obtain a larger future award. In some implementations, the gaming system may provide an additional award, such as an award multiplier for completing more than one puzzle during the play of the game.

In some implementations, the gaming system may clear puzzles when the gaming system provides an award associated with the puzzle (e.g., for a completed puzzle or for a puzzle that included a threshold quantity of puzzle pieces). In some implementations, the gaming system may keep puzzle pieces in puzzles that did results in an award for one or more next plays of the game. As noted above, the obtained puzzle pieces may be available to other players if the current player ends their gaming session. Such continuity of the puzzle pieces in puzzles encourages players to play a gaming system when the players realize that one or more puzzles are partially complete and thus closer to providing an award. In some implementations where the gaming system provides and award associated with an incomplete puzzle (e.g., where a puzzle contained a threshold quantity of puzzle pieces, but is incomplete), the gaming system may keep the puzzle pieces in the puzzle for one or more next plays of the game or for one or more next gaming sessions.

At block 427, the gaming system updates the credit balance determined at block 407 based on the amount of the award or awards determined at block 426. It is understood that some implementations of the method 400 may not include block 427 and that the gaming system may update the player's credit balance at other times (e.g., at block 447), such as at the completion of the game.

At block 431, the gaming system determines whether a bonus game should be triggered. In some implementations, the gaming system triggers the bonus game feature based on, for example, an output from a bonus controller (e.g., bonus server 303). In some implementations, the gaming system randomly triggers the bonus game based on, for example, an output from a random number generator. In some implementations, the gaming system randomly triggers the bonus game after occurrence of a threshold number of events since trigging a previous bonus game (e.g., after wager values in a gaming session exceed a threshold, after a quantity of plays of a game, after a predetermined period of time, etc.). In some of such implementations, the gaming system triggers the bonus game based on determining that the symbols displayed at block 419 include a trigger symbol, a quantity of trigger symbols, a particular sequence of trigger symbols, or some other suitable triggering event. For example, the gaming system may trigger the bonus game if a sequence of three trigger symbols are displayed along an active pay line.

In block 431, if the gaming system determines the bonus game has been triggered (e.g., block 431 is “Yes,”) then the gaming system may execute the bonus game at block 432 and proceed to block 433.

On the other hand, if the gaming system determines that the bonus game has not been triggered (e.g., block 431 is “No”), then the method 400 proceeds to block 433. In some implementations, as indicated in block 433, the gaming system may receive a request or signal to end game play or “cash out” via an input device (e.g., an input device 115) of the gaming system (e.g., which would end the gaming session). In such a situation, the gaming system may dispense a value to the player, through a value dispenser, based on the player's gaming credit balance as illustrated in block 435 and operation 400 ends.

If the gaming system has not received a request or signal to end game play (e.g., the player continues the gaming session to play another play of the game), the process of method 400 may return to block 405, as indicated by off-page connector C. The gaming system may store one or more of the obtain puzzle pieces in puzzles and make these partially completed puzzles available for the next play of the game. The gaming system may receive, via a player input device, a wager for another play of the game and continue method 400 from block 405. However, in some implementations, the wager may not be accepted if the player has fewer credits than the player's selected wager amount.

In some implementations, the gaming system enables the player to review one or more puzzle collection sets before, during, or after a play of the game. In some implementations, the gaming system may display the puzzle collection sets with partially completed puzzles and provide an incentive for a player to select one or more of the puzzle collection sets for a play of a game. For example, if a puzzle collection set associated with the highest awards (e.g., puzzle collection set 640C) has partially completed puzzles while the other puzzle collection sets have fewer or no partially completed puzzles, the player may decide to place a larger wager to obtain the puzzle collection set 640C. The player may believe that puzzle collection set 640C includes puzzles that can results in awards sooner than lower value puzzles in other puzzle collection sets. In some implementations, the gaming system may be configured to provide one or more puzzles with one or more puzzle pieces without players obtaining puzzle pieces for such puzzles during a play of a game. For example, in some implementations, when the gaming system clears a puzzle, the gaming system may determine to start the puzzle with one or more puzzle pieces for a next play of a game to entice players to play (e.g., so the players do not perceive that a puzzle or puzzle collection set must be filled from scratch or without any advantage).

FIGS. 5A-5C show example images of a game screen 500 displayed by a gaming system (e.g., gaming system 100) in accordance with aspects of the present disclosure. More specifically, FIGS. 5A-5C illustrate example screen shots the game screen 500 that may be displayed by a display device (e.g., display device 120) in one implementation of the gaming system. As detailed previously herein, implementations consistent with the present disclosure can provide a game including a first part of a game (e.g., a base game) and a second part of a game (e.g., a bonus game). In some implementations, game screen 500 may be displayed on first display device 120 of gaming system 100 illustrated in FIG. 1. However, any other suitable display device may be used.

The game screen 500 illustrates a set of a video reels 502A, 502B, 502C, 502D, and 502E as shown in FIG. 5A for a base game. As also illustrated in FIG. 5A, the reels 502A-502E are displayed substantially side by side. It should be appreciated that reels 502A-502E can be displayed with any suitable amount of separation or no separation. It should be appreciated that the game shown in game screen 500 is merely representative and may have more or fewer game elements (e.g., reels, symbol display areas, symbols, etc.) shown in the game screen 500. It should also be appreciated that other games may be used for the primary or base game. It should further be appreciated that game screen 500 and associated symbol display areas may be independent of or not associated with video reels. In some implementations, some base games may lack reels.

In some implementations, the reels 502A-502E are each respectively associated with a set of symbols or a symbol set, where each symbol set includes a quantity of symbols. The symbol sets can be associated with the same or different symbols. The sets of symbols may include numbers, letters, geometric figures, symbols, images, characters, blank symbols (e.g., the absence of symbols), animations, transparent symbols (e.g., symbols that permits underlying symbols to be visible), or any other suitable graphical depiction. The symbols in the symbol sets may include pay symbols, special or designated symbols, or other suitable types of symbols.

In FIG. 5A, the game screen 500 depicts a plurality of symbol display areas (a.k.a., symbol display positions) 510A, 510B, 510C, 510D, 510E, 510F, 510G, 510H, 510I, 510J, 510K, 510L, 510M, 510N, and 510O. The plurality of symbol display areas can be associated in a manner that provides the appearance of game or slot machine reels. It should also be appreciated that the symbol display areas may not be associated with game reels in some implementations. As illustrated in FIG. 5A, symbol display areas 510A, 510B, 510C, 510D, 510E, 510F, 510G, 510H, 510I, 510J, 510K, 510L, 510M, 510N, 510O are associated in a manner that provides the appearance of a set of five slot machine game reels. In some implementations, the plurality of symbol display areas that provide the appearance of five game reels may be arranged in a manner that visibly shows three symbol display positions (e.g., symbol display areas) of each of the five game reels (e.g., visible stop positions on the reels). For example, the symbol display areas 510A-510O are each associated with positions on reels 502A-502E, respectively. As shown in FIGS. 5A-5C, symbol display areas 510A, 510F, and 510K are associated with reel 502A; symbol display areas 510B, 510G, and 510L are associated with reel 502B; symbol display areas 510C, 510H, and 510M are associated with reel 502C; and symbol display areas 510D, 510I, and 510N are associated with reel 502D; and symbol display areas 510E, 510J, and 510O are associated with reel 502E. The gaming system may display fewer or more reels in various implementations.

The arrangement illustrated in the implementation of FIGS. 5A-5C thus creates a visible display area of the reels 502A-502E having three visible symbol positions for each reel. When viewed together, reels 502A-502E appear as a 3-row by 5-column reel array in game screen 500. In other implementations, smaller or larger visible areas of the reels may be displayed. That is, the reels 502A-502E may show fewer or a larger number of visible symbol display areas. In some implementations, some symbol display areas can be hidden to hold generated symbols for use when the reels are nudged. While symbol display areas are illustrated with defined boxes or borders, it should be appreciated that in some implementations, game screen 500 may not use defined borders or make borders visible. In some implementations with reels, the gaming system may display reel borders, but not borders between symbol display areas. In some implementations without reels, the gaming system does not display reel borders. It should also be appreciated that in some implementations, the symbol display areas are other shapes or not defined shapes and may not be associated with game elements or objects other than reels.

Reels 502A-502E may display a plurality of symbols that the gaming system generates from the symbol sets in their respective symbol display areas, as illustrated in FIG. 5A. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict spinning reels or spinning symbols.

Game screen 500 also includes several information areas and buttons 505A-505I. These information areas and buttons 505A-505I are illustrated in an example configuration and positioning associated with a particular arrangement, but may be arranged in any suitable manner in different implementations. In some implementations, game screen 500 may include more or fewer display areas and buttons 505A-505I than illustrated. In some implementations, game screen 500 may not show any information areas or buttons. Information area 505A illustrates an example value of one credit for the game displayed in game screen 500, and in the example shown in FIG. 5A, information area 505A illustrates a value of $0.01. Button 505B illustrates a software button that the player can select to view how many credits the player has accumulated and monetary value of these credits if the player wishes to cease playing (e.g., a product of a value per credit shown in information area 505A and a quantity of remaining credits shown in information area 505C). Information areas 505C illustrate an example of the amount of the player's available credits. In the example shown in FIG. 5A, information area 505C illustrates that the player has 2000 available credits after placing a wager. Information area 505D illustrates the amount of credits a player has won. Because FIG. 5A illustrates an example display associated with a start of a play of a game, the information area 505D shows zero credits have been won during the play of the game.

Button 505E illustrates a software button that the player can select to place a bet or wager. It should be appreciated that the functionality of button 505E may also be replicated or replaced with a hardware button on the gaming system 100. Information area 505F illustrates that the player has selected to wager 10 credits per pay line. Button 505G illustrates a software button that the player can select to determine how many pay lines to wager on. It should be appreciated that the functionality of button 505G may also be replicated or replaced with a hardware button on the gaming system 100. Information area 505H identifies a quantity of pay lines on which the player chooses to wager, and in the example shown in FIG. 5A, information area 505H indicates that the player selected to wager on 20 pay lines. It should be appreciated that in some implementations, the player does not select a quantity of pay lines. Button 505I illustrates a software button that the player can select to obtain information about the game, change certain aspects of the game, obtain help, place an order, etc. It should be appreciated that some figures discussed in the present disclosure may not show information areas and buttons 505A-505I for ease of explanation.

To start a gaming session, a player may provide the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game for the gaming session and to also place wagers on the play of the game. The gaming system may provide a visual indication of the player's credit balance to the player as discussed above in information area 505C.

To initiate the play of the game, the player may select a wager, using a suitable input device (e.g., a button, lever, motion detector, etc.) on the gaming system, to deduct credits necessary to play the game and to identify the player's wager. Along with receiving the player's wager, the gaming system may receive pay line selections or other game functions the player wishes to activate in exchange for the wager. In some implementations, before, during, or after the player places the wager, the gaming system enables the player to review one or more available puzzle collection sets. For example, the gaming system may display available puzzle collection sets in as illustrated in FIG. 6 in some implementations. FIG. 6 illustrates three puzzle collection sets 640A, 640B, and 640C. In various implementations, the gaming system may have more or fewer puzzle collection sets. In some implementations, the gaming system may include a different puzzle set associated with each different wager. In some implementations, the gaming system may further include a different puzzle set associated with each different wager in each available credit denomination. In some implementations, puzzle collection set 640A is associated with a minimum wager value. In some implementations, puzzle collection set 640B is associated with a median wager value. In some implementations, puzzle collection set 640C is associated with a maximum wager value.

The puzzle collection sets 640A-640C can be associated with any suitable wager values. In some implementations, the wager values can be a range, a threshold, or a specific wager value. Puzzle collection set 640A may comprise one or more puzzles. In some implementations, as illustrated in FIG. 6, puzzle collection set 640A includes four puzzles 610A, 610B, 610C, and 610D. In some implementations, the four puzzles 610A, 610B, 610C, and 610D are each associated with a different puzzle (e.g., forming the letters D, C, B, and A, respectively). In some implementations, the four puzzles 610A, 610B, 610C, and 610D can be each associated with a different quantity of puzzle pieces, where the puzzle pieces can be different shapes and sizes. In some implementations, the four puzzles 610A, 610B, 610C, and 610D can be different sizes. As shown in the four puzzles 610A, 610B, 610C, and 610D of FIG. 6, these puzzles are incomplete and show the outline of pieces needed to complete the puzzle. In some implementations, the four puzzles 610A, 610B, 610C, and 610D may show an outline of the final image that is revealed when the puzzle is complete. In some implementations, the final image is hidden until the puzzle is complete or partially complete. In some implementations, the gaming system may display puzzles of the puzzle collection sets with puzzle pieces that were randomly added to the puzzles or were added based on prior plays of a game. In some implementations, as illustrated in FIG. 6, the four puzzles 610A, 610B, 610C, and 610D can each be associated with a different award value. The features of puzzles 620A, 620B, 620C, 620D, 630A, 630B, 630C, and 630D can be similar to the features described above with respect to puzzles 610A-610D and are not repeated herein.

In some implementations, the gaming system receives a player input that results in a selection of one puzzle collection set from the plurality of puzzle collection sets for a play of a game. In some implementations, the player selects a puzzle collection set from the plurality of puzzle collection sets. In some such implementations, the puzzle collection sets are associated with a minimum wager level that a player makes to obtain the selected puzzle collection set for the play of the game. In some implementations, the player places a wager at the gaming system and the gaming system uses this player input to determine which one of the puzzle collections sets to select from the plurality of puzzle collection sets.

Returning to FIG. 5A, for illustration purposes, the player placed a minimum wager and the gaming system selected the puzzle collection set 640A for the play of the game based on the minimum wager. In some implementations, as shown in FIG. 5A, the gaming system displayed the outline of incomplete puzzles 530A, 530B, 530C, and 530D in the game screen 500 of the selected puzzle collection set. In some implementations, the gaming system may display outlines of symbols associated with puzzles as shown in 532A, 532B, 532C, and 532D. In some implementations, the gaming system does not show such symbols in the incomplete puzzles 530A-530D. In some implementations, the gaming system does not show outlines of the puzzle pieces necessary to complete the puzzle. In some implementations, the gaming system may provide an indication of the quantity of puzzle pieces that are needed to complete the puzzle or to obtain a threshold quantity of puzzle pieces to win an award. In some implementations, as the player obtains puzzle pieces for the displayed puzzles, the gaming system will display the obtained puzzle pieces and reveal the symbols of the puzzles.

The player may also actuate a game start button, a spin button, a lever (not shown), or some other suitable input device. The gaming system may deduct the appropriate credits from the player's credit balance (e.g., in information area 505C) after the wager or at any suitable time. For example, the gaming system may deduct a wager per pay line in information area 505F multiplied by a number of pay lines in information area 505H.

Upon receipt of the player's wager and activation of a play of the game, the gaming system may show a display of spinning reels for the reels 502A-502E. The spinning may appear to occur in a vertical top to bottom direction or in a vertical bottom to top direction (not shown), or in a combination of vertical directions (not shown). In some implementations, the gaming system randomly determines symbols from the associated symbol sets for reels 502A-502E, respectively. As noted above, the gaming system may rely on random generation performed by a pseudo RNG, a true RNG, or hardware RNG specifically designed for gaming systems. In some implementations, the gaming system may also update the player's credit meter (information area 505C) to reflect the player's available credit balance. As shown in FIG. 5A, the player's credit meter (information area 505C) was decremented by 200 credits from 2200 to 2000 to reflect a prior 200 credit wager the player placed for the play of the game.

The gaming system may display the determined symbols in symbol display areas 510A-510O, as illustrated in FIG. 5A. Symbols displayed on reels 502A-502E illustrate the randomly generated symbols from the symbol sets after the reels have stopped spinning. As illustrated in FIG. 5A, the gaming system randomly determined and displayed symbols in symbol display areas 510A-510O for reels 502A-502E. It should be appreciated that the displayed symbol combinations are merely for explanatory purposes and the gaming system may randomly determine or generate any suitable combination of symbols based on defined symbol sets associated with the reels 502A-502E.

In some implementations, the gaming system may evaluate the displayed symbols on reels 502A-502E for winning symbols or winning symbol combinations. As noted above, the player may have wagered on one or more pay lines (e.g., such as 20 pay lines shown in information area 505H). In some implementations, at least the active (e.g., the wagered on pay lines) are evaluated for winning symbol combinations. Any suitable number of pay lines may be used to evaluate winning symbol combinations. The gaming system may use other suitable methods of evaluating the displayed symbols for winning symbols or winning symbol combinations (e.g., ways pays, scatter combinations, etc.)

In some implementations, the gaming system may evaluate the generated symbols on reels 502A-502E for triggering symbols or combinations of symbols that trigger features for the play of the game (hereafter referred to as “triggering symbol combinations”). For example, the gaming system may evaluate winning symbols or winning symbol combinations to determine if any such winning symbols or winning symbol combinations are associated with puzzle pieces. If the gaming system determines that winning symbols or winning symbol combinations are associated with puzzle pieces, the gaming system may generate an appropriate quantity of puzzle pieces and display such puzzle pieces in the appropriate puzzles 530A-530D. In some implementations, as shown in FIG. 5A, the gaming system may determine that no winning symbols or winning symbol combinations were generated and therefore, the gaming system does not generate puzzle pieces for the puzzles 530A-530D.

If the gaming system does not trigger a bonus game, the player may continue the gaming session (e.g., play another consecutive play of the game) by executing another play of the game (e.g., part of a gaming session). That is, the player may place another wager and start a new play of the game as noted above. However, continued game play is dependent on the number of credits remaining in the player's credit balance. The player may choose to cash out. The player may select an input button associated with a cash out request, where the processor of the gaming system may receive a cash out signal or request. In such an instance, the gaming system can provide the player a value based on the player's credit balance using any of the value items discussed above (bills, coins, vouchers, etc.).

In FIG. 5B, the game screen illustrates the player playing another play of the game. In the illustrated implementation, the player placed a minimum wager and the gaming system selected the puzzle collection set that includes puzzles 530A-530D. The gaming system also determined and displayed new symbols for symbol display areas 510A-510O. In some implementations, as noted above, the gaming system evaluated the new determined symbols in symbol display areas 510A-510O for winning symbols and winning symbol combinations. In this play of the game, as illustrated in FIG. 5B, the gaming system determined a first winning symbol combination of three A symbols in symbol display areas 510A, 510B, and 510C along pay line 550A. In this play of the game, as illustrated in FIG. 5B, the gaming system also determined a second winning symbol combination of five C symbols in symbol display areas 510K, 510L, 510M, 510N, and 510O along pay line 550B. In some implementations, the gaming system may evaluate winning symbols or winning symbol combinations to determine if any such winning symbols or winning symbol combinations are associated with puzzle pieces and a displayed puzzle. In the illustrated example, the gaming system determined that the winning symbol combination of A symbols are associated with an A puzzle 530D. In some implementations, the gaming system may generate a predetermined or randomly determined quantity of A puzzle pieces to add to the A puzzle 530D. In the illustrated example, the gaming system generated eight puzzle pieces and added these eight puzzle pieces to puzzle 530D. As shown in FIG. 5B, the part of the A symbol 532D is now displayed in solid line representing the eight A puzzle pieces that were added to the A puzzle 530D. In the illustrated example, the gaming system determined that the winning symbol combination of C symbols are associated with an C puzzle 530B. In some implementations, the gaming system may generate a predetermined or randomly determined quantity of C puzzle pieces to add to the C puzzle 530B. In the illustrated example, the gaming system generated ten puzzle pieces and added these ten puzzle pieces to the C puzzle 530B. As shown in FIG. 5B, the part of the C symbol 532B is now displayed in solid line representing the ten C puzzle pieces that were added to the C puzzle 530B.

As also illustrated in FIG. 5B, the gaming system determines an award for the play of the game based on the displayed winning symbol combinations of A symbols and C symbols in accordance with an associated pay table (not shown). In some implementations, the gaming system may evaluate the puzzles to determine if any puzzle obtained a threshold quantity of puzzle pieces or if any puzzle was completed. In FIG. 5B, the gaming system determined that no puzzle obtained a threshold quantity of puzzle pieces and no puzzle was completed. The gaming system may update the player's gaming credit balance (e.g., 525 credits in 505D) in accordance with the calculated value of the award for the winning combination of A symbols and C symbols. In some implementations, the play of the game ends.

If the gaming system does not trigger a bonus game, the player may continue the gaming session (e.g., play another consecutive play of the game) by executing another play of the game (e.g., part of a gaming session). That is, the player may place another wager and start a new play of the game as noted above. However, continued game play is dependent on the number of credits remaining in the player's credit balance. The player may choose to cash out. The player may select an input button associated with a cash out request, where the processor of the gaming system may receive a cash out signal or request. In such an instance, the gaming system can provide the player a value based on the player's credit balance using any of the value items discussed above (bills, coins, vouchers, etc.). In some implementations, as noted above, the gaming system may store the obtained puzzle pieces for the puzzle 530B and puzzle 530D for one or more next plays of the game or one or more next gaming sessions.

In FIG. 5C, the game screen illustrates the player playing another play of the game. In the illustrated implementation, the player placed a minimum wager and the gaming system selected the puzzle collection set that includes puzzles 530A-530D again. In some implementations, the gaming system may maintain the previously obtained puzzle pieces shown in FIG. 5B. For example, in FIG. 5C, puzzle 530B and puzzle 530D kept the puzzle pieces obtained in the prior play of the game. In doing so, the gaming system allows players to build upon prior plays of the game in the hope of obtaining a quick path to an award associated with a puzzle.

The gaming system also determined and displayed new symbols for symbol display areas 510A-510O. In some implementations, as noted above, the gaming system evaluated the new determined symbols in symbol display areas 510A-510O for winning symbols and winning symbol combinations. In this play of the game, as illustrated in FIG. 5C, the gaming system determined a first winning symbol combination of three A symbols in symbol display areas 510F, 510G, and 510M along pay line 552A. In this play of the game, as illustrated in FIG. 5C, the gaming system also determined a second winning symbol combination of five C symbols in symbol display areas 510K, 510L, 510H, 510D, and 510J along pay line 552B. In some implementations, the gaming system may evaluate winning symbols or winning symbol combinations to determine if any such winning symbols or winning symbol combinations are associated with puzzle pieces and a displayed puzzle. In the illustrated example, the gaming system determined that the winning symbol combination of A symbols are associated with an A puzzle 530D. In some implementations, the gaming system may generate a predetermined or randomly determined quantity of A puzzle pieces to add to the A puzzle 530D. In the illustrated example, the gaming system generated one puzzle piece and added this one puzzle piece to puzzle 530D. As also shown in FIG. 5C, additional portions of the A symbol 532D is now displayed in solid line representing the additional one A puzzle piece that was added to the A puzzle 530D. In the illustrated example, the gaming system determined that the winning symbol combination of C symbols are associated with C puzzle 530B. In some implementations, the gaming system may generate a predetermined or randomly determined quantity of C puzzle pieces to add to the C puzzle 530C. In the illustrated example, the gaming system generated 11 puzzle pieces and added these 11 puzzle pieces to puzzle 530B. As shown in FIG. 5C, the remainder of the C symbol 532B is now displayed in solid line representing the five additional C puzzle pieces that were added to the C puzzle 530B.

As also illustrated in FIG. 5C, the gaming system determines an award for the play of the game based on the displayed winning symbol combinations of A symbols and C symbols in accordance with an associated pay table (not shown). In some implementations, the gaming system may evaluate the puzzles to determine if any puzzle obtained a threshold quantity of puzzle pieces or if any puzzle was completed. In FIG. 5C, the gaming system determined that the puzzle 530B was completed. In some implementations, the gaming system may highlight the puzzle 530B in some suitable manner. The gaming system may provide an award for the puzzle based on an award associated with completing the puzzle. FIG. 6 is an example of puzzle collection sets that also illustrate a prize values for the puzzles and illustrates that the C puzzle 530B is associated with a 500 credit award. The gaming system may indicate the puzzle award to the player such as by displaying the 500 credit award via indicator 534 as shown in FIG. 5C. The gaming system can alert the player to the puzzle award in any suitable manner. The gaming system may update the player's gaming credit balance (e.g., 1025 credits in 505D) in accordance with the calculated value of the award for the winning combination of A symbols and C symbols and the puzzle award. In some implementations, the play of the game ends.

In some implementations, the gaming system may generate more puzzle pieces for a particular puzzle than is required to complete the puzzle and provide additional awards for left over or unused puzzle pieces. For example, in some implementations, the gaming system may have generated 15 puzzle pieces for the C puzzle 530B rather than the 11 puzzle pieces required to complete the C puzzle 530B shown in FIG. 5C. In this example, four puzzle pieces for the C puzzle 530B would be left over and not used to complete the C puzzle in FIG. 5C. In some implementations, when the gaming system generates puzzle pieces are left over or unused (e.g., after filling a puzzle to completion), the gaming system may provide additional awards for one or more puzzle pieces that remain after filling a particular puzzle. For example, the gaming system may provide an additional award for one or more of the four left over puzzle pieces. In some implementations, the gaming system provides an additional award for each puzzle piece that remains after filling a particular puzzle (e.g., the gaming system may provide four separate awards for each of the four unused puzzle pieces in this example implementation). In some implementations, left over or unused puzzle pieces can also or alternatively be applied to the next puzzle that replaces the C puzzle in a next play of a game. In some implementations, the complete C puzzle remains complete for one or more plays of the game. In some implementations, while the C puzzle remains complete, when the gaming system generates more puzzle pieces for the complete C puzzle in a play of a game, the gaming system may provide one or more additional awards for the unused puzzle pieces that are associated with the complete C puzzle.

In some implementations, where a player has not completed a puzzle and plans to leave a gaming system, the gaming system may enable the player to exchange one or more puzzle pieces in the puzzles for awards. For example, in FIG. 5C, the player added a certain quantity of puzzle pieces to the A puzzle 530D during a gaming session. In some implementations, the gaming system may enable the player to exchange one or more of the collected puzzle pieces in the A puzzle 530D for one or more awards when the player is cashing out or otherwise leaving the gaming system. In some implementations, the gaming system restricts the player to exchanging puzzle pieces that the player has added to the puzzles. In some implementations, the gaming system does not apply restrictions on which or how many puzzle pieces the player can exchange for awards. In some implementations, the puzzle pieces exchanged for awards are removed from the puzzle. In some implementations, the value the player obtains for exchanging the puzzle pieces for awards is lower or different than the award provided to the player where the player completed a puzzle associated with the exchanged puzzle pieces. In some implementations, the player can exchange puzzle pieces for awards at any time during a play of a game. In some implementations, the player can exchange puzzle pieces from incomplete and complete puzzles at any time during a play of a game.

If the gaming system does not trigger a bonus game, the player may continue the gaming session (e.g., play another consecutive play of the game) by executing another play of the game (e.g., part of a gaming session). That is, the player may place another wager and start a new play of the game as noted above. However, continued game play is dependent on the number of credits remaining in the player's credit balance. The player may choose to cash out. The player may select an input button associated with a cash out request, where the processor of the gaming system may receive a cash out signal or request. In such an instance, the gaming system can provide the player a value based on the player's credit balance using any of the value items discussed above (bills, coins, vouchers, etc.). It should be appreciated that while a bonus game is discussed herein, in some implementations, the gaming system does not include a bonus game.

In some implementations that include a bonus game, the bonus game also provides one or more puzzle collection sets that can be played similar to how the puzzle collection sets were played, as described above in connection with FIGS. 5A-5C. In some implementations, when a bonus game is triggered, the current state (e.g., including collected puzzle pieces) of the puzzle collection set played in the base game is stored for later use and the gaming system may select one or more puzzles or puzzle collection sets for the bonus game, similar to how the gaming system selected the puzzles or puzzle collection sets for the base game. For example, the gaming system may store the puzzle collection set (e.g., 530A-530D) displayed in FIG. 5C for later use in the same or a later play of the game when a bonus game is triggered. The state of the puzzle collection set displayed in FIG. 5C can be restored later in the same or different play of the game with the same amount of puzzle pieces completed and uncompleted. In some implementations, when the bonus game is complete, the gaming system may store the current state of the puzzle collection set used in the bonus game for a later play in a bonus game. In some implementations, when the bonus game is complete, the gaming system may clear or reset the current state of the puzzle collection set used in the bonus game. In some implementations, the gaming system may provide awards for one or more puzzles. In some implementations, the gaming system may provide awards for one or more puzzles that are complete. In some implementations, the gaming system may provide awards for one or more puzzles that are incomplete. In some implementations, the gaming system may provide awards for one or more puzzles that are complete and one or more puzzle that are incomplete. In some implementations, the features described herein technologically improve the gaming system by performing selective evaluations of displayed symbols. For example, when evaluating the determined symbols for symbols that are associated with puzzles and puzzle pieces (e.g., symbols displayed in symbol display areas 510A-510O), the gaming system may limit its evaluation of such displayed symbols for displayed symbols within symbol display areas where the gaming system has determined winning symbol combinations, rather than evaluating all symbols or including symbols not in winning symbol combinations in its evaluation. By minimizing its evaluation of displayed symbols within winning symbol combinations, the gaming system reduces the quantity of symbols it evaluates, enabling the gaming systems to complete a play of a game more quickly than systems that evaluate all of the displayed symbols. By doing so, in some implementations, the disclosed gaming systems can increase the usage rate of the gaming system by allowing more games to be completed in a given time period (e.g., games per hour) and by reducing power consumed during one or more plays of a game.

Moreover, in some implementations, reducing the quantity of displayed symbols that are evaluated for generating puzzle pieces for displayed puzzles, also reduces the processing load and memory consumption of the gaming system. By doing so, implementations of the disclosed gaming system avoid reading and writing certain symbols from memory, which increases the efficiency of the gaming system by conserving processor loading and reduces memory consumption. And, when such efficiency improvements are made and applied to the hundreds or thousands of game evaluations in multiple installations of the gaming system (e.g., multiple devices installed at a casino), implementations of the disclosed gaming system provide casino game operators sizable gains in machine efficiency, which is a technological improvement. It should be appreciated that in some implementations with the technological improvement, the gaming system may still evaluate symbols outside of a winning symbol combination for other types of winning symbols.

In some implementations, the features described herein technologically improve the gaming system by performing selective evaluations of displayed puzzles. For example, when evaluating puzzles to determine puzzle awards, the gaming system may limit its evaluation of puzzles to puzzles that received new puzzle pieces during a play of the game, rather than evaluating all puzzles at the end of every play of the game. By minimizing its evaluation of puzzles for puzzle awards, the gaming system reduces the quantity of puzzles it evaluates, enabling the gaming systems to complete a play of a game more quickly than systems that evaluate all of the displayed symbols. By doing so, in some implementations, the disclosed gaming systems can increase the usage rate of the gaming system by allowing more games to be completed in a given time period (e.g., games per hour) and by reducing power consumed during one or more plays of a game. Moreover, in some implementations, reducing the quantity of displayed puzzles that are evaluated, also reduces the processing load and memory consumption of the gaming system. By doing so, implementations of the disclosed gaming system avoid reading and writing certain puzzle and/or puzzle pieces from memory, which increases the efficiency of the gaming system by conserving processor loading and reduces memory consumption. And, when such efficiency improvements are made and applied to the hundreds or thousands of game evaluations in multiple installations of the gaming system (e.g., multiple devices installed at a casino), implementations of the disclosed gaming system provide casino game operators sizable gains in machine efficiency, which is a technological improvement. It should be appreciated that in some implementations with the technological improvement, the gaming system may still evaluate one or more puzzles for plays of the game.

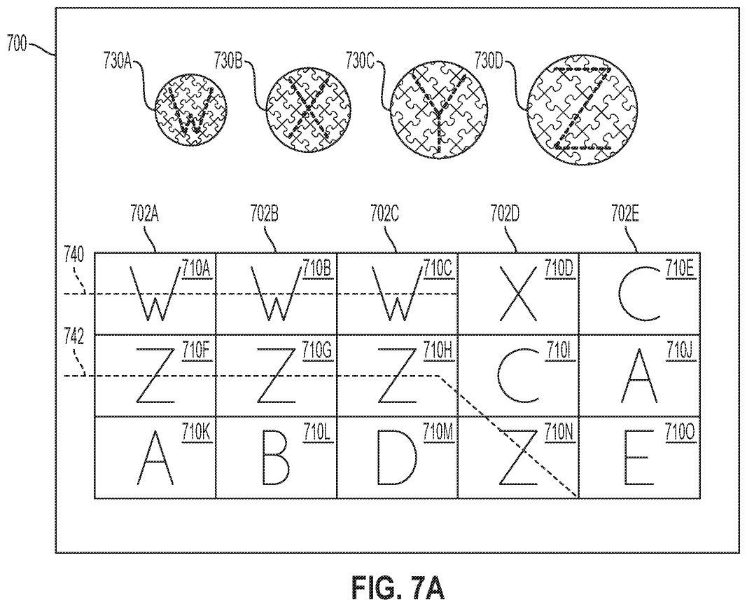

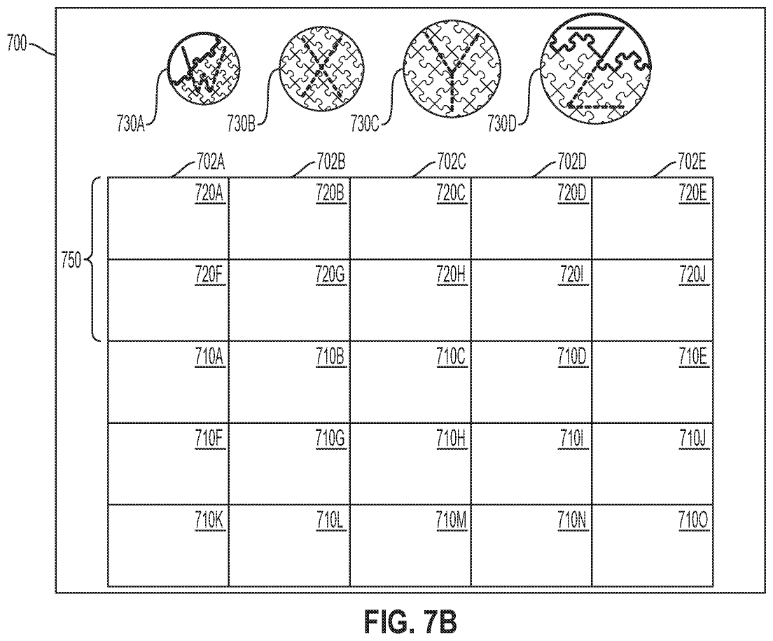

FIGS. 7A and 7B illustrate another implementation of the gaming system that is similar to the gaming system discussed above in connection with FIGS. 4A, 4B, and 5A-5C. The similar features are not described again for the sake of brevity. FIGS. 7A and 7B further disclose some implementations of the gaming system where the gaming system can expand symbol display areas or reels to provide additional symbols for a game Similar to the gaming system discussed in FIG. 5A-5C, the gaming system of FIG. 7A illustrates reels 702A, 702B, 702C, 702D, and 702E. The reels 702A-702E further depict symbol display areas 710A, 710B, 710C, 710D, 710E, 710F, 710G, 710H, 710I, 710J, 710K, 710L, 710M, 710N, and 710O. In some implementations, the gaming system displays puzzles from a selected puzzle collection set. In FIG. 7A, the gaming system illustrates a puzzle collection set that includes puzzles 730A, 730B, 730C, and 730D that display the outlines of symbols W, X, Y, and Z. In this example, the puzzles are started without existing puzzle pieces (e.g., from scratch) because no puzzle pieces are displayed in the puzzles 730A-730D.

As illustrated in FIG. 7A, the gaming system determined and displayed symbols for symbol display areas 710A-710O. In some implementations, as noted above, the gaming system evaluates the new determined symbols in symbol display areas 710A-710O for winning symbols and winning symbol combinations. In this example implementation, as illustrated in FIG. 7A, the gaming system determined a first winning symbol combination of three W symbols in symbol display areas 710A, 710B, and 710C along pay line 740. In this play of the game, as illustrated in FIG. 7A, the gaming system also determined a second winning symbol combination of four Z symbols in symbol display areas 710F, 710G, 710H, and 710N along pay line 742. In some implementations, the gaming system may evaluate winning symbols or winning symbol combinations to determine if any such winning symbols or winning symbol combinations are associated with puzzle pieces and a displayed puzzle. In the illustrated example, the gaming system determined that the winning symbol combination of W symbols are associated with a W puzzle 730A. In some implementations, the gaming system may generate a predetermined or randomly determined quantity of W puzzle pieces to add to the W puzzle 730A. As is illustrated in FIG. 7B, the gaming system generated a certain quantity of puzzle pieces and added these puzzle pieces to puzzle 730A. As also shown in FIG. 7B, additional parts of the W symbol are now displayed in solid line representing the additional W puzzle pieces that were added to the W puzzle 730A. Returning to FIG. 7A, in the illustrated example, the gaming system also determined that the winning symbol combination of Z symbols are associated with a Z puzzle 730D. In some implementations, the gaming system may generate a predetermined or randomly determined quantity of Z puzzle pieces to add to the Z puzzle 730D. In the illustrated example of FIG. 7B, the gaming system generated a quantity of puzzle pieces and added these puzzle pieces to puzzle 730D. As also shown in FIG. 7B, additional parts of the Z symbol are now displayed in solid line representing the additional Z puzzle pieces that were added to the Z puzzle 730D.

In some implementations, as previously discussed in FIGS. 5A-5C, the gaming system may determine an award for the play of the game based on the displayed winning symbols or winning symbol combinations in accordance with an associated pay table (not shown). In some implementations, the gaming system may evaluate the puzzles to determine if any puzzle obtained a threshold quantity of puzzle pieces or if any puzzle was completed. The gaming system may provide an award for any puzzle(s) that obtained a threshold quantity of puzzle pieces or for any puzzle(s) were completed. The gaming system may update the player's gaming credit balance in accordance with the calculated value of the award for the puzzle award. In some implementations, the play of the game ends.

In some implementations, the player may continue the gaming session (e.g., play another play of the game) by executing another play of the game (e.g., part of a gaming session). That is, the player may place another wager and start a new play of the game as noted above. However, continued game play is dependent on the number of credits remaining in the player's credit balance. The player may choose to cash out. The player may select an input button associated with a cash out request, where the processor of the gaming system may receive a cash out signal or request. In such an instance, the gaming system can provide the player a value based on the player's credit balance using any of the value items discussed above (bills, coins, vouchers, etc.).

In some implementations, as illustrated in FIG. 7B, the gaming system may enhance the reels. In some implementations, the gaming system may add additional symbol display areas to the reels. In some implementations, the gaming system randomly determines (e.g., using the processor of the gaming system or a bonus controller) to add one or more symbol display areas to one or more reels. In some implementations, the gaming system can add the one or more symbol display areas to the one or more reels before, during, or after a play of the game. As illustrated in FIG. 7B reference 750, the gaming system added two additional symbol display areas (e.g., 720A, 720B, 720C, 720D, 720E, 720F, 720G, 720H, 720I, and 720J) to each of reels 702A-702E. In various implementations, the gaming system may add any suitable quantity of additional symbol display areas to any of the reels. In some implementations, the gaming system may add additional symbol display areas more than once during a play of a game. In some implementations, the gaming system can determine to add additional symbol display areas based on other game related events. In some implementations, the gaming system can determine to add additional symbol display areas based on how long the player has played at the gaming system, how much the player has wagered, how much the player has wagered over a gaming session, etc. In some implementations, the gaming system maintains the added symbol display areas for reels for one or more plays of the game. In some implementations, the gaming system removes the added symbol display areas after a number of plays of the game. In some implementations, the gaming system maintains the added symbol display areas during the player's gaming session and the gaming system and returns the reels to their original quantity of symbol display area when the player cashes out of the gaming system. In some implementations, the gaming system removes added symbol display areas based on a random determination. It should be appreciated that adding additional symbol display areas enables the gaming system to generate and display additional symbols. These additional symbols provide the player with additional opportunities to obtain winning symbols and winning symbol combinations. The additional symbols from the additional symbol display area also enables the player more opportunities to obtain puzzle pieces for puzzles than are otherwise available in a game with fewer symbol display areas.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a display device, an input device, a value dispenser, a random number generator, a memory device, and a processor, wherein the memory device stores program instructions that, when executed by the processor, cause the processor to:
receive, via the input device, a user selection, where the user selection results in selection of a puzzle collection from a plurality of puzzle collection sets for a play of a game;
determine, using the random number generator, a plurality of symbols for a plurality of symbol display areas;
display, on the display device, the plurality of symbols in the plurality of symbol display areas;
determine at least one winning symbol combination in the plurality of symbols;
determine a quantity of puzzle pieces to display in the selected puzzle collection based on the at least one winning symbol combination;
display the quantity of puzzle pieces in the puzzle collection;
determine one or more awards based on the puzzle collection displaying a threshold quantity of puzzle pieces; and
issue a value from the value dispenser based on the one or more awards upon receipt of a cash out request.

2. The gaming system of claim 1, wherein the plurality of puzzle collection sets comprises at least two different puzzle collections sets.

3. The gaming system of claim 2, wherein a first one of the at least two different puzzle collection sets comprises at least one puzzle that is different from at least one puzzle in a second one of the at least two different puzzle collection sets.

4. The gaming system of claim 1, wherein the selected puzzle collection comprises a plurality of different puzzles.

5. The gaming system of claim 4, wherein the quantity of puzzle pieces are associated with one of the plurality of different puzzles.

6. The gaming system of claim 5, wherein displaying the quantity of puzzle pieces in the puzzle collection further comprises displaying the quantity of puzzle pieces in the associated one of the plurality of different puzzles.

7. The gaming system of claim 1, wherein the threshold quantity of puzzle pieces comprises less than all of the puzzle pieces necessary to fill a puzzle of the select puzzle collection.

8. The gaming system of claim 1, wherein the threshold quantity of puzzle pieces comprises all of the puzzle pieces necessary to fill a puzzle of the select puzzle collection.

9. The gaming system of claim 4, further comprising determining at least two different awards when at least two of the plurality of puzzles of the selected puzzle collection are determined to each comprise a threshold quantity of puzzle pieces.

10. The gaming system of claim 1, further comprising determining an award based on the at least one winning symbol combination.

11. The gaming system of claim 1, wherein the user selection further comprises a wager level.

12. A method of operating a gaming system comprising:
receiving, via an input device, a user selection, where the user selection results in selection of a puzzle collection from a plurality of puzzle collection sets for a play of a game;
determining, using a random number generator and a processor, a plurality of symbols for a plurality of symbol display areas;
displaying, on a display device, the plurality of symbols in the plurality of symbol display areas;
determining at least one winning symbol combination in the plurality of symbols;
determining a quantity of puzzle pieces to display in the selected puzzle collection based on the at least one winning symbol combination;
displaying the quantity of puzzle pieces in the puzzle collection;
determining one or more awards based on the puzzle collection displaying a threshold quantity of puzzle pieces; and
issuing a value from a value dispenser based on the one or more awards upon receipt of a cash out request.

13. The method of claim 12, wherein the plurality of puzzle collection sets comprises at least two different puzzle collections sets.

14. The method of claim 13, wherein a first one of the at least two different puzzle collection sets comprises at least one puzzle that is different from at least one puzzle in a second one of the at least two different puzzle collection sets.

15. The method of claim 12, wherein the selected puzzle collection comprises a plurality of different puzzles.

16. The method of claim 12, further comprising generating a puzzle clearing symbol, wherein the processor removes at least one puzzle piece from the puzzle collection when the processor generates the puzzle clearing symbol.

17. The method of claim 16, wherein displaying the quantity of puzzle pieces in the puzzle collection further comprises displaying the quantity of puzzle pieces in the associated one of the plurality of different puzzles.

18. The method of claim 12, wherein the threshold quantity of puzzle pieces comprises less than all of the puzzle pieces necessary to fill a puzzle of the select puzzle collection.

19. The method of claim 12, wherein the threshold quantity of puzzle pieces comprises all of the puzzle pieces necessary to fill a puzzle of the select puzzle collection.

20. A non-transitory computer-readable storage device having program instructions stored therein, the program instructions being executable by a processor to cause a gaming system to:
receive, via an input device, a user selection, where the user selection results in selection of a puzzle collection from a plurality of puzzle collection sets for a play of a game;
determine, using a random number generator and the processor, a plurality of symbols for a plurality of symbol display areas;
display, on a display device, the plurality of symbols in the plurality of symbol display areas;
determine, using the processor, at least one winning symbol combination in the plurality of symbols;
determine, using the processor, a quantity of puzzle pieces to display in the selected puzzle collection based on the at least one winning symbol combination;
display, on the display device, the quantity of puzzle pieces in the puzzle collection;
determine, using the processor, one or more awards based on the puzzle collection displaying a threshold quantity of puzzle pieces; and
issue a value from a value dispenser based on the one or more awards upon receipt of a cash out request.
